(19) United States
(12) Patent Application Publication
(10) Pub. No.: US 2013/0086216 A1
(43) Pub. Date: Apr. 4, 2013

(54) METHOD AND SYSTEM FOR INDIVIDUALIZED LISTING PLACEMENTS IN WEB PAGES

(71) Applicant: ADKNOWLEDGE, INC., Kansas City, MO (US)

(72) Inventors: Kevin Eppinger, Kansas City, MO (US); Deebu Jacob, Mission, KS (US); Scott Goldblatt, Overland Park, KS (US)

(73) Assignee: ADKNOWLEDGE, INC., Kansas City, MO (US)

(21) Appl. No.: 13/633,415

(22) Filed: Oct. 2, 2012

Related U.S. Application Data
(60) Provisional application No. 61/542,998, filed on Oct. 4, 2011.

(51) Int. Cl. G06F 15/16

(52) U.S. Cl. 709/217

(57) ABSTRACT

Systems and methods serve to provide individualized content to users, via their computers, linked to a network, such as the Internet, which these users may not be aware of The content includes, for example, articles and advertisements, in electronic format. The content is accessible by activating activatable links to the content, the activatable links underlying text or images in web pages that have been rendered to the browsing application of a computer associated with a user.

### CROSS-REFERENCES TO RELATED APPLICATIONS

This application is related to and claims priority from commonly owned U.S. Provisional Patent Application, Ser. No. 61/542,998, entitled: METHOD AND SYSTEM FOR INDIVIDUALIZED LISTING PLACEMENTS IN WEB PAGES, filed Oct. 4, 2011, which is incorporated by reference in its entirety herein.

### TECHNICAL FIELD

The present disclosed subject matter relates to web pages, and in particular, to providing web page content.

### BACKGROUND

As the Internet expands, the amount of content available over the Internet expands even more. Content providers would like their content to be in front of users, consumers and other individuals or groups, on a constant basis. As a result of the users, consumers and other individuals or groups being exposed to the content of the content provider, the content provider can profit from advertising, such as pay per click (PPC) advertising, on their web pages and web sites.

### SUMMARY

This document references terms that are used consistently or interchangeably herein. These terms, including variations thereof, are as follows.

The term “click”, “clicks”, “click on”, “clicks on” involves the activation of a computer pointing apparatus, such as a device commonly known as a mouse, on a location on a computer screen display, for example, an activatable link, that causes an action of the various software and or hardware supporting the computer screen display.

A “banner” is a graphic that appears on the monitor of a user, typically over a web page being viewed. A banner may appear on the web page in forms such as inserts, pop ups, roll ups, scroll ups, and the like.

A “web site” is a related collection of World Wide Web (WWW) files that includes a beginning file or “web page” called a home page, and typically, additional files or “web pages.” The term “web site” is used collectively to include “web site” and “web page(s).”

A uniform resource locator (URL) is the unique address for a file, such as a web site, a web page, an item of content, etc., which is accessible on the Internet.

A “server” is typically a remote computer or remote computer system, or computer program therein, that is accessible over a communications medium, such as the Internet, that provides services to other computer programs (and their users), in the same or other computers.

Pay Per Click (PPC), also known as price per click and cost per click, as used herein, is the amount of money that an advertiser, web site promoter, or other party who owns or is associated with a web site, will pay to a system administrator for providing their advertisement, listing, link or the like to a user, and the user clicks their mouse or pointing device on the advertisement, listing, link or the like, such that the user's browser is directed to the targeted web site associated with the advertiser, web site promoter, or other party who owns or is associated with the targeted web site.

A “client” is an application that runs on a computer, workstation or the like and relies on a server to perform some operations, such as sending and receiving e-mail.

“n” and “nth” in the description below and the drawing figures represents the last member of a series or sequence of servers, databases, caches, components, listings, links, data files, etc.

“Listing,” and “listing text” are used interchangeably herein to describe a word, group of words or phrases, associated with an advertisement, article, item or content or an item of information which covers a link or hyperlink to the server or computer that hosts the actual advertisement, article, item or content or an item of information in a format suitable for electronic presentation to a computer or the like.

The present disclosed subject matter provides systems and methods for providing individualized content to users, via their computers, linked to a network, such as the Internet, which these users may not be aware of. This is because the content available over the World Wide Web (WWW), e.g., the Internet, is voluminous, and it is almost impossible for a single user to know every web site available over the World Wide Web. The disclosed subject matter provides systems and methods for selecting and suggesting individualized content for users, based upon an analysis of a web page or portion thereof which such users select. The content includes, for example, web pages, advertisements, etc., for example, in the form of listings, the listings including hyperlinks to servers and other destinations along, on or over the network.

Also disclosed are systems and methods to provide individualized content, such as web page content, to users, via their computers, linked to a network, such as the Internet, which these users may not be aware of The content includes, for example, articles and advertisements, in electronic format. The content is accessible by activating activatable links to the content, the activatable links underlying text or images in web pages, which have been rendered to the browsing application of a computer associated with a user.

The present disclosed subject matter is directed to a method for providing content to electronic pages over a communications network. The method includes a processor of a first computer system linked to the communications network (for example, the Internet), electronically crawling a first item of electronic content (for example, an article in electronic formats including digital format), from a content source, for example, a content server (for example, associated with a publisher), linked to the communications network for text; a processor of the first computer system, electronically parsing the text; and, obtaining, by a processor of the first computer system, at least one search term and at least one relevancy score for the at least one search term (for example, a keyword), based on at least a portion of the parsed text. Based on the at least one search term and the at least one relevancy score, and in response to the first item of electronic content being accessed on a first electronic page (for example, a web page), a processor of the first computer system, searching the content source for at least one second item of electronic content (for example, articles in electronic formats including digital format) to be accessible from a second electronic page (for example, a web page) for being viewed. The second electronic page includes activatable data corresponding to the at least one second item of electronic content. The first computer system provides the activatable data for accessing the at least one second item of electronic content over the communications network, to the second electronic page.

Another aspect of the disclosed subject matter is directed to a computer system for providing content to electronic pages over a communications network. The system comprises at least one processor and a recommendation engine. The at least one processor is programmed to: crawl a first item of electronic content from a content source linked to the communications network for text; parse the text; obtain at least one search term and at least one relevancy score for the at least one search term, based on at least a portion of the parsed text; and, provide activatable data to access second items of electronic content, to a second electronic page. The recommendation engine in electronically coupled to the at least one processor, and is configured for searching the content source for the second items of electronic content, to be provided as the activatable data for accessing each of the second items of electronic content, to the second electronic page for being viewed, the searching based on the at least one search term and the at least one relevancy score, and in response to the first item of electronic content being accessed on a first electronic page.

Another aspect of the disclosed subject matter is directed to a computerized system for providing content to electronic pages over a communications network. The system comprises a storage medium for storing computer components, and a processor for executing the computer components. The computer components comprise: a first computer configured for crawling a first item of electronic content from a content source linked to the communications network for text; a second computer component configured for parsing the text; a third computer component configured for obtaining at least one search term and at least one relevancy score for the at least one search term, based on at least a portion of the parsed text; a fourth computer component configured for searching the content source for second items of electronic content to be provided to a second electronic page as activatable data for being viewed on the second electronic page, the searching based on the at least one search term and the at least one relevancy score, and in response to the first item of electronic content being accessed on a first electronic page; and a fifth computer component configured for providing the activatable data for accessing each of the second items of electronic content, to the second electronic page. There is also a sixth computer component configured for rendering the second electronic page to the browsing application of the computer of a user for display.

Another aspect of the disclosed subject matter is directed to a computerized system for providing content to electronic pages over a communications network. The system comprises a storage medium having stored thereon data about a first item of electronic content from a content source linked to the communications network for text, and a computer, coupled to the storage medium. The computer is configured to: (a) crawl items of electronic content from a content source linked to the communications network for text; (b) parse the text; (c) obtain at least one search term and at least one relevancy score for the at least one search term, based on at least a portion of the parsed text; (d) search the content source for second items of electronic content to be provided as activatable data for accessing each of the second items of electronic content, to a second electronic page for being viewed, the searching based on the at least one search term and the at least one relevancy score, and in response to the first item of electronic content being accessed on a first electronic page; and (e) provide the activatable data for accessing each of the second items of electronic content, to the second electronic page. The computer of the system is also configured to provide the activatable data in association with text or images, and to render the second electronic page to the browsing application of the computer of a user for display.

### BRIEF DESCRIPTION OF DRAWINGS

Attention is now directed to the drawings, where like reference numerals or characters indicate corresponding or like components. In the drawings:

FIG. 1 is a diagram of an exemplary system on which an embodiment of the disclosed subject matter is performed;

FIGS. 2A and 2B are flow diagrams of processes in accordance with embodiments of the disclosed subject matter of FIG. 1;

FIGS. 3A-3E are diagrams of screen shots or screen or monitor displays detailing portions of the flow diagrams of FIGS. 2A and 2B;

FIG. 3F is a diagram of a screen shot or screen or monitor display of another embodiment in accordance with the disclosed subject matter;

FIG. 4A is a diagram of an exemplary system on which an embodiment of the disclosed subject matter is performed;

FIG. 4B is a diagram of the database of FIG. 4A;

FIGS. 4C-1 and 4C-2 together are a diagram of a subdatabase of FIG. 4B, FIG. 4C-1 is the left side of the diagram and FIG. 4C-2 is the right side of the diagram;

FIGS. 4D-4K are diagrams of subdatabases and caches of the database of FIG. 4B;

FIGS. 5A and 5B are flow diagrams of processes in accordance with embodiments of the disclosed subject matter of FIGS. 4A-4K; and

FIGS. 6, 7, 8A and 9A are diagrams of screen shots or screen or monitor displays detailing portions of the flow diagrams of FIGS. 5A and 5B;

FIGS. 8B, 9B, 10, 11A, 11B and 12 are diagrams of screen shots or screen or monitor displays for additional processes in accordance with the disclosed system of FIGS. 4A-4K; and

FIGS. 13A and 13B, and 14A and 14B, are diagrams of screen shots or screen or monitor displays for other embodiments of the disclosed subject matter.

### DETAILED DESCRIPTION OF THE DRAWINGS

Throughout this document, numerous textual and graphical references are made to trademarks, trade dress, web sites, and the like. These trademarks, trade dress and web sites are the property of their respective owners, and are referenced only for explanation purposes herein.

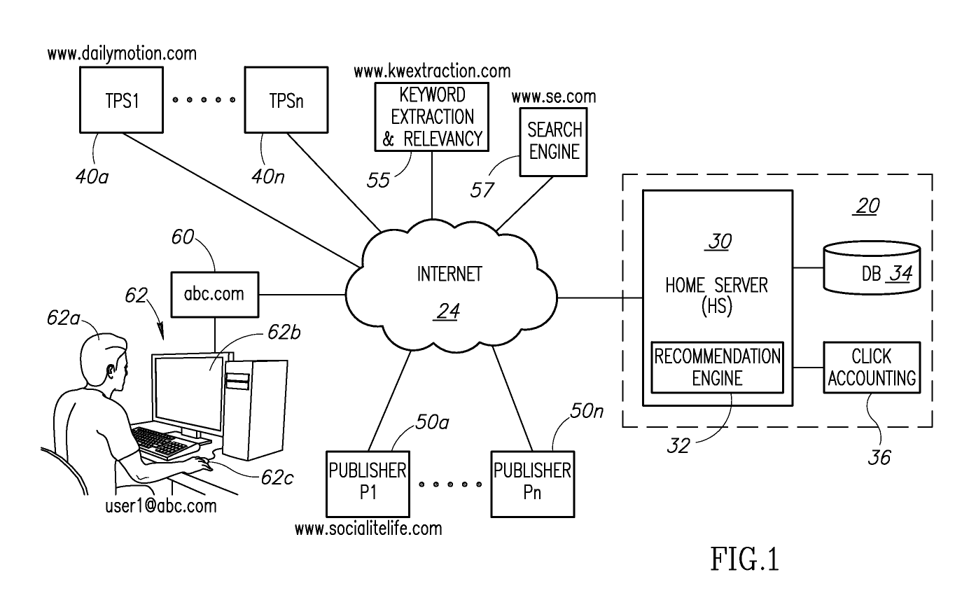

FIG. 1 shows the present disclosed subject matter in an exemplary operation. The present disclosed subject matter employs a system 20, which is linked, directly or indirectly, wired, wirelessly, or combinations thereof, to a network, including a communications or computer network, such as a wide area network (WAN), that is, for example, a public network, such as the Internet 24. The system 20 is, for example, a computer system, formed of various servers, server components, computers, computer components, computerized components, machines, workstations and the like, and includes a home server (HS) 30, also known as the main server.

The home server 30 may be one or more servers, server components, computers, computer components, computerized components, machines, workstations and the like, and are associated with storage media, and processors, both internal and external. The home server 30 may also include, or be associated with, computers, machines, computer and computerized devices and/or components, processors, storage media, modules, engines, and combinations thereof. The home server 30 is detailed further below.

There are, for example, numerous servers that work in conjunction with the system 20, and are linked directly or indirectly, wired or wirelessly, or combinations thereof, to the network 24. These servers, for example, include third party servers (TPS1-TPSn) 40a-40n, each representative of third party, typically unrelated to the system 20, and publisher servers (P1-Pn) 50a-50n, representative of various publishers, typically unrelated to the system 20. There is also a server 55 for keyword extraction and relevancy determination, with a URL of www.kwextraction.com, representative of servers that extract keywords and perform relevancy determinations from these keywords, by assigning scores, and a search engine server 57, with a URL of www.se.com, representative of search engine servers. Search engine server 57, for example, functions as a search engine, like that, for example of Bing™ (www.bing.com, from Microsoft of Redmond Wash.), Yahoo™ (www.yahoo.com). Servers 55, 57 may be part of the system 20, but may also be independent of the system 20, as shown.

There are also domain servers, for example, server 60, which hosts the domain abc.com. This server 60 is representative of a multitude of domain servers linked to the network 24, as detailed above. This server 60 supports a computer 62 of a user 62a, with an e-mail addresses user1@abc.com, which accesses the various servers linked to the network 24, such as the publisher servers 50a-50n, the third party servers 40a-40n, and the home server (HS) 30.

The servers 30, 40a-40n, 50a-50n, 55, 57, and 60 are linked (either directly or indirectly) to each other and an endless number of other servers and the like, via the network, for example, the Internet 24. These servers 30, 40a-40n, 50a-50n, 55, 57, and 60 are arranged along the network 24, so they are in electronic and/or data communication, directly or indirectly, with each other.

The servers 40a-40n, 50a-50n, 55, 57, and 60 include multiple components for performing the requisite functions as detailed below, and the components may be based in hardware, software, or combinations thereof. The servers 40a-40n, 50a-50n, 55, 57, and 60 may also have internal storage media and/or be associated with external storage media, which functions with the server structures and components to perform the server functions detailed herein.

These servers 40a-40n, 50a-50n, 55, 57, and 60 may be computer systems, one or more servers, server components, computers, computer components, computerized components, machines, workstations and the like. While various servers have been listed, this is exemplary only, as the present disclosed subject matter can be performed on an endless numbers of servers and associated components, which are in some way linked to a network, such as the Internet 24, both directly and indirectly.

The user 62a, representative of all users of the disclosed subject matter, has (or is associated with) a computer 62 (such as a multimedia personal computer with a Pentium® CPU, that employs a Windows® operating system) that may use an e-mail client. The computer 62 is linked to the Internet 24. The computer 62 includes a monitor or display screen 62b and is operated by an activatable pointer, such as a mouse 62c or the like. The computer 62 includes an e-mail client (detailed above), installed thereon, that provides the user 62a with a unique address and the ability to utilize one or more e-mail addresses. For example, the user 62a has an e-mail address, user1@abc.com, through which he receives his e-mail from the domain server 60, which hosts the domain “abc.com,” of which the user 62a is a member. The computer 62 of the user 62a includes a web browser, browsing software, application, or the like, to access web sites or web pages from various servers and the like, on the Internet 24. Some exemplary web browsers/web browsing software/browsing applications include, Internet Explorer®, from Microsoft, Redmond, Wash., Netscape® Navigator®, and Mozilla Firefox™.

The home server (HS) 30 is of an architecture that includes one or more components, devices, computer devices, modules, engines and the like, for providing numerous additional server functions and operations, for example, web page and web site hosting and administration, web page and text crawling, natural language processing, keyword and text extraction, URL designation, linking to additional servers over the network 24, comparison and matching functions, policy and/or rules processing, various search and other operational engines, browser directing and redirecting functions, data sending, storing and receiving, and the like. The home server 30 includes multiple devices, components, and the like, for performing the requisite functions as detailed below, and the devices, components, and the like, may be based in hardware, software, or combinations thereof. The home server (HS) 30 includes various processors, including microprocessors, for performing the server functions and operations detailed herein, and storage media, either internal or associated therewith, operable with the server components, modules, engines and the like. The home server (HS) 30 may be associated with additional caches, databases, as well as numerous other additional storage media, both internal and external thereto. For explanation purposes, the home server (HS) 30 may have a uniform resource locator (URL) of, for example, www.homeserver.com.

The home server (HS) 30 includes a recommendation engine 32, which is configured for searching internal databases, storage media, etc. (of the home server 30) and publisher databases for listings (which result in recommendations for content on the web page being viewed). The home server 30 also includes a database (DB) 34 for storing keywords and rankings (including relevancy rankings) thereof, and a module 36 for click accounting, for example, performing functions such as tracking and mapping clicks, administering pay per click or pay for performance amounts, and the like.

While a single home server (HS) 30 is shown, the home server (HS) 30 may be formed of multiple servers, computers, machines, computer and computerized devices and/or components, processors, storage media, modules, engines, and the like.

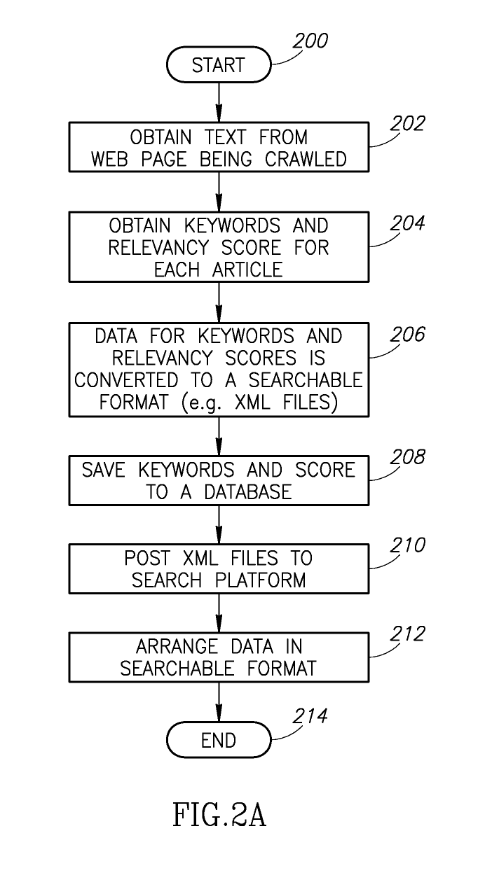

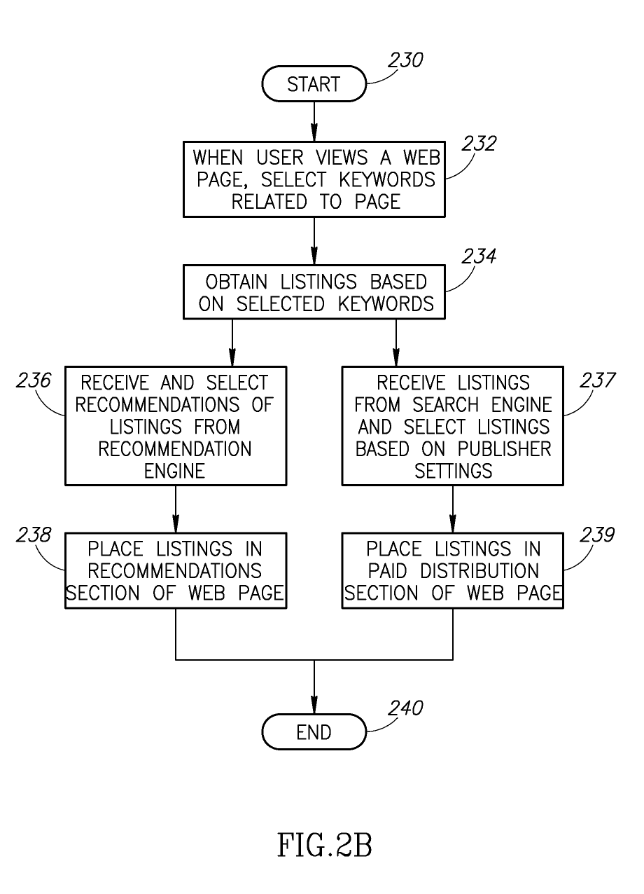

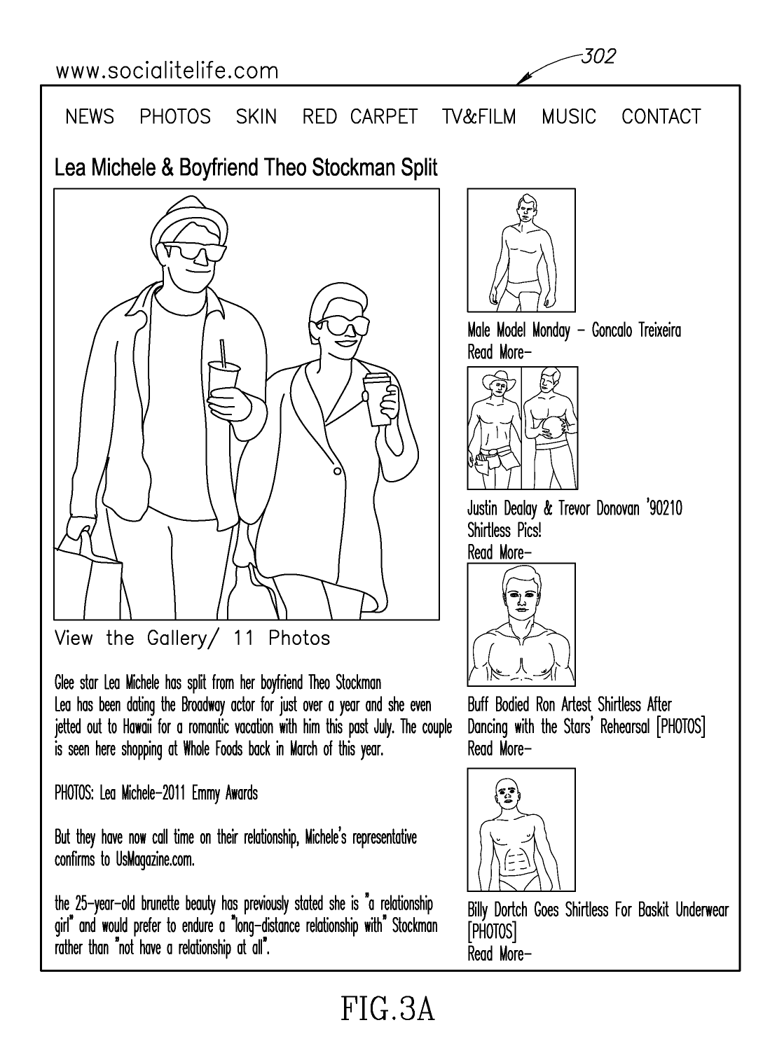

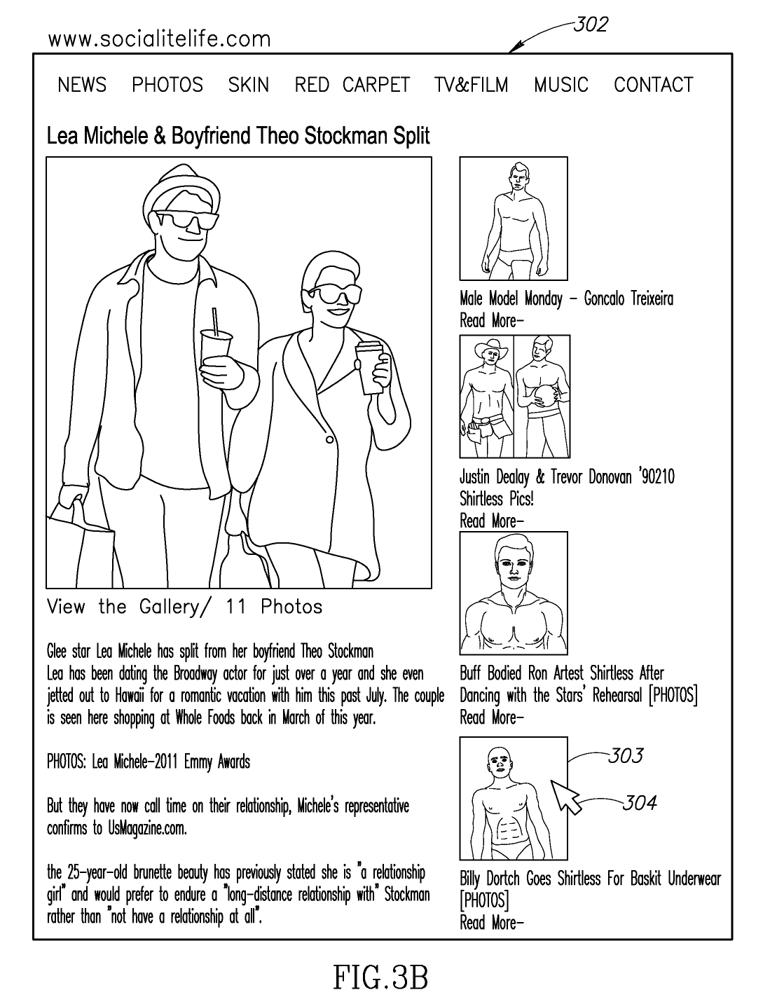

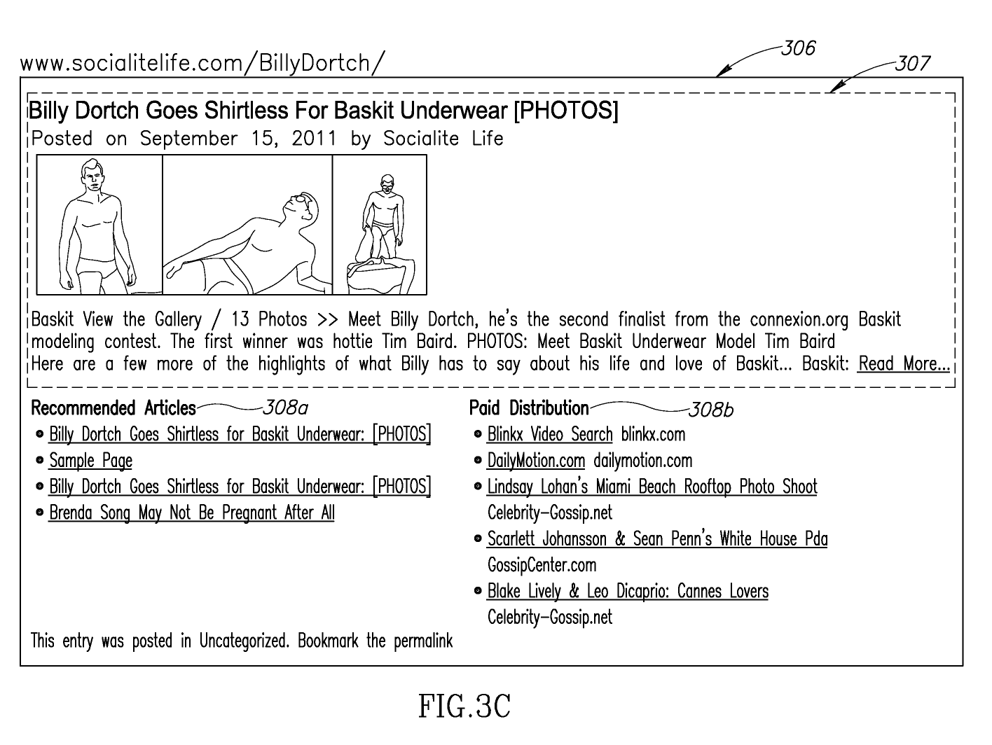

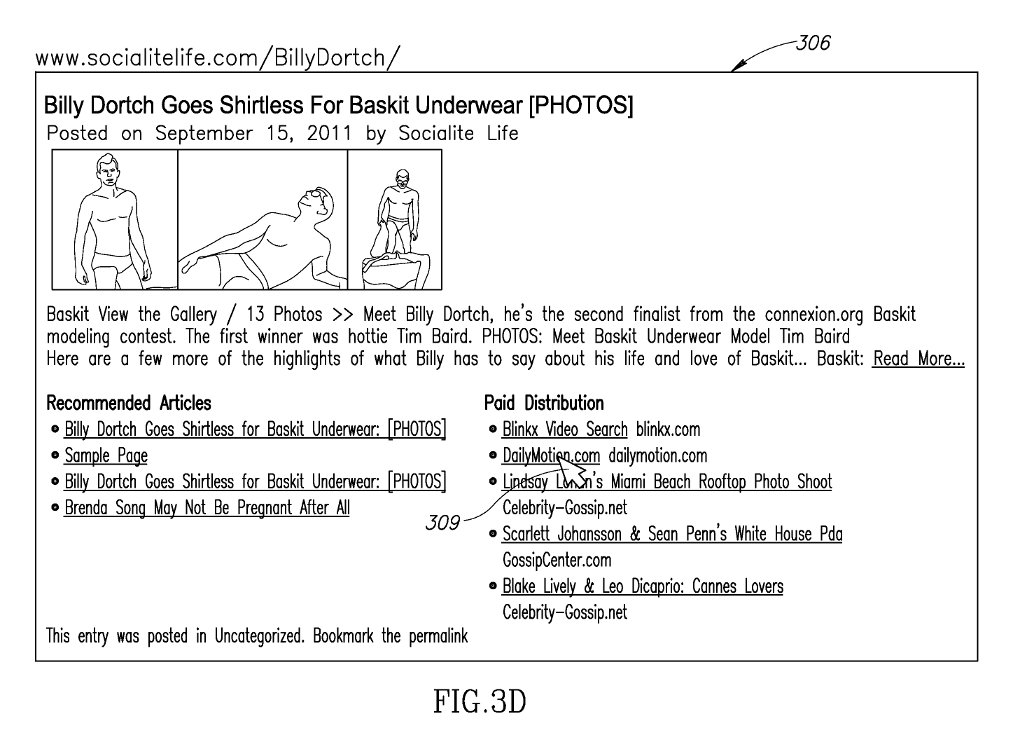

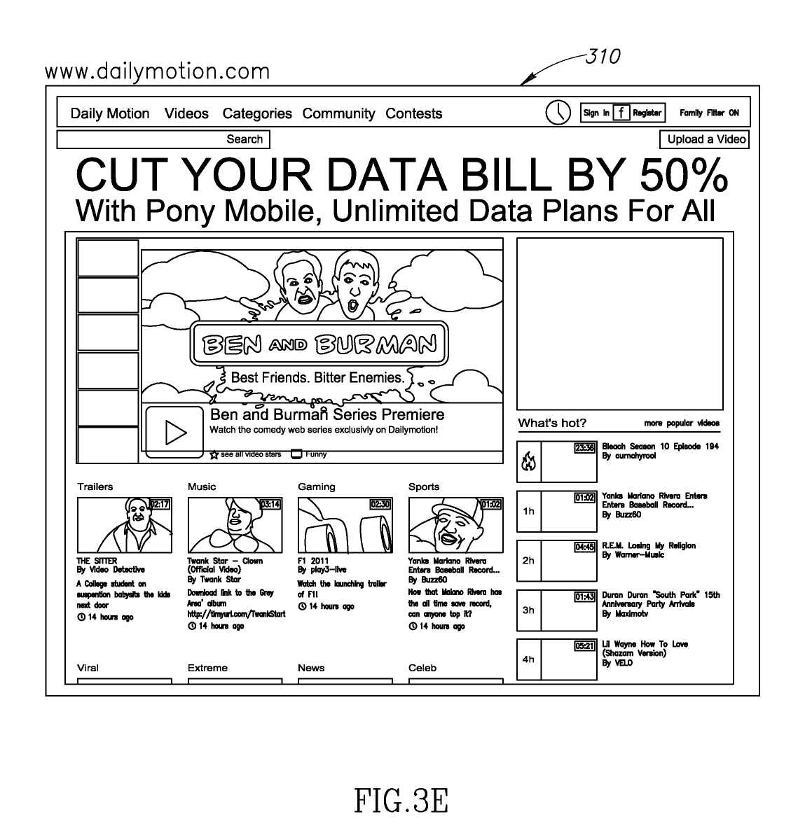

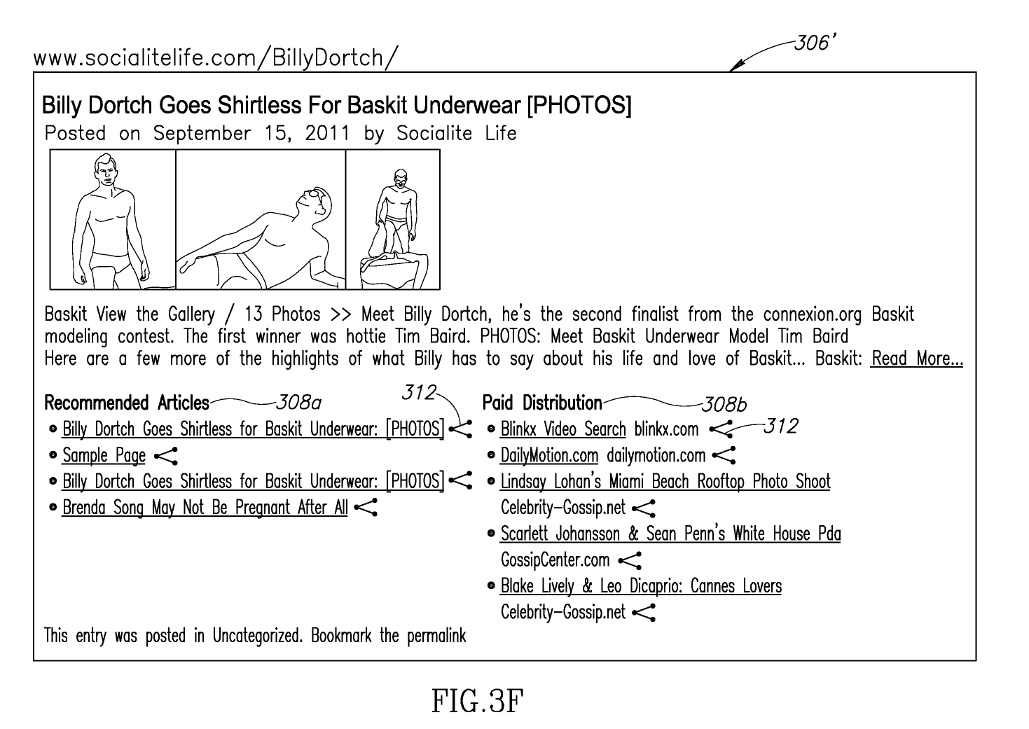

Turning also to FIGS. 2A and 2B, there are shown exemplary implementations of processes or methods, hereinafter “processes,” in accordance with embodiments of the disclosed subject matter. FIGS. 2A and 2B are flow diagrams of the processes (methods), for obtaining and selecting listings based on the web page, for example, the text of an article or text being viewed by the user, the web page/web site to which the browsing application of the computer of the user is directed. FIGS. 3A-3E are screen diagrams or screen shots, which appear on the monitor or display screen of the computer of the user, during the processes of FIGS. 2A (FIGS. 3A and 3B) and 2B (FIG. 3C), and after the process of FIG. 2B (FIGS. 3D and 3E).

Initially, in FIG. 2A, at block 200, the first process starts as the web page 302, with, for example, the URL www.socialitelife.com (FIG. 3A) (of publisher P1 and hosted by Publisher P1's server 50a-the web page 302 may also be hosted by a third party server (TPS) 40a-40n associated with publisher P1's server 50a) is being viewed by the user, for example, user 62a via the associated computer 62, on the display screen 62b.

The user 62a clicks his mouse or pointing device 62c on the item of interest 303 (the click represented by the arrow 304), as shown in FIG. 3B. The item 303 is hyperlinked to the web page 306 of FIG. 3C, to which the browsing application is intended to be directed. Web page 306, for example, is also hosted by the server 50a of publisher P1 with the URL www.socialitelife.com/BillyDortch/, although this web page 306 may be hosted by any other server linked to the network 24, including one of the third party servers (TPS) 40a-40n.

Automatically, in response to the mouse click 304, the home server 30, to which the click 304 is mapped, via the publisher server P1 50a, obtains the text associated with the web page 306 being crawled, at block 202. For example, the web page 306 being crawled includes the article text (broken line box 307 of FIG. 3C), and, which, for example is parsed. The parsed text is sent to the server 55, with, for example, the URL www.kwextraction.com, where keywords, search terms, or other relevant text, phrases or the like (collectively “keywords”), in natural language, are obtained, and isolated, and assigned relevancy scores, at block 204. This keyword extraction and relevancy server 55 is, for example, operated by AlchemyAPI™, available from Orchestr8, LLC, 2300 15th Street, Suite 320, Denver, Colo., 80202 (www.alchemyapi.com).

The process moves to block 206, where extracted keywords and relevancy scores (in the form of data) are sent to the home server 30. The home server 30 converts or places the data for the aforementioned extracted keywords and relevancy scores into a searchable format. For example, the home server 30 formats the extracted keywords and relevancy scores by creating XML files of the data for the extracted keywords and relevancy scores, based on a predetermined schema for a search platform. For example, one search platform used is SOLR, from The Apache Software Foundation of 1901 Munsey Drive, Forest Hill, Md. 21050-2747, (http://lucene.appache.org/solr/). The home server 30 may employ its temporary storage media during this process.

The extracted keywords and relevancy scores, in the desired searchable format, for example, XML (Extensible Markup Language), are stored in the database of the home server 30, for example, database (DB) 34, at block 208. The converted data, for example, the XML files created at block 206, are posted to a searchable platform (e.g., SOLR), at block 210. The data, e.g., the data from the XML files, is arranged in a searchable format using an algorithm, at block 212. For example, the algorithm is Lucene, available from The Apache Software Foundation of 1901 Munsey Drive, Forest Hill, Md. 21050-2747, http://lucene.apache.org, which runs on the home server 30 or a server associated with the home server 30 and/or the system 20. This first process ends at block 214.

This first process, including the processes detailed on blocks 200, 202, 204, 206, 208, 210, 212 and 214, for example, occurs prior to the web page 306 of FIG. 3C being rendered to the browsing application of the computer 62 of the requesting user 62a. The processes of blocks 202 to 212 (and 214) are, for example, performed automatically, and in real time. These processes are typically performed one after the other.

The second process (of FIG. 2B) operates contemporaneous with, and typically shortly thereafter the first process (of FIG. 2A, for example, after block 214 of FIG. 2A), but can operate anytime after the first process is complete, or while the first process is ending. It is during this second process, that the web page 306 of FIG. 3C is rendered to the browsing application of the computer 62 of the requesting user 62a.

Directing attention to FIG. 2B, the second process starts at block 230. The user 62a now sees (via his monitor or display screen 62b) the web page 306 of FIG. 3C, as the browser associated with the user's computer 62 is directed to the URL www.socialitelife.com/BillyDortch/ (for example, hosted by the publisher server P1 50a).

From the web page having been crawled, as detailed above, for example, web page 306 and, in particular, the article (box 307), the home server 30, via its programmed processors, selects keywords related to the web page, at block 232. For example, this keyword selection may be random, context based, or yield based, and may also involve use of the relevancy scores assigned to the keywords in the first process, detailed above. If yield based, keywords are grouped and ordered based on how the listings (for example, advertisements) perform based on user and geographical metrics.

The selected keywords (in the form of data) are used for obtaining listings, at block 234. The selected keywords, for example, the same selected keywords, are processed, for example, by two processes, one process defined by blocks 236 and 238, and another process by blocks 237 and 239. The selected keywords, for block 236 are processed (at block 234) by the recommendation engine 32 of the home server 30, which obtains listings from the system 20 or from servers over the Internet 24. The selected keywords for block 237 are processed at block 234 by being sent to a search engine, as represented for example, by the search engine server 57 (www.se.com). One search engine is, for example, Miva (www.miva.com), from Adknowledge, Inc., of Kansas City, Mo., 64112 (www.adknowledge.com).

At block 236, the Recommendation Engine 32 (of the home server 30) searches its internal databases and publisher databases, over the network 24, to receive and select recommendations of listings. The process moves to block 238, where the home server 30 places the listings into the web page, for example, web page 306, in the recommendations section 308a of the web page 306.

With respect to the process at block 237, the search engine, such as that of the search engine server 57, applies the keyword(s) (keyword(s) data) and returns listings to the home server 30. The home server 30 receives the listings and selects the listings based on publisher settings (programmed into the home server 30), at block 237. From block 237, the process moves to block 239, where the home server 30 places the listings into the web page, for example, web page 306, in the paid distribution section 308b of the web page 306.

With the listings in place on the web page via hyperlinks to the corresponding web sites, for example, hosted on the third party servers (TPS1-TPSn) 40a-40n, at blocks 238 and 239 respectively, the web page 306 of FIG. 3C is now rendered to the browsing application of the computer 62 of the user 62a. The processes move from blocks 238 and 239, respectively, to block 240, where this second process ends. The user 62a now views the rendered web page 306 of FIG. 3C, as his browser is directed to this web page 306 (with the URL www.socialitelife.com/BillyDortch/).

The processes of blocks 236, 238, 240 and 237, 239, 240 are performed contemporaneous in time with respect to each other, but can be performed simultaneous with each other or one after another. The processes of blocks 232, 234, 236, 238, 237 and 239 are, for example, performed automatically and in real time.

Turning now to FIG. 3D, the user 62a has interest in a paid listing for Dailymotion.com. Upon clicking the corresponding link (the click represented by the arrow 309), the browsing application of the computer 62 of the user 62a is directed, for example, via the home server 30, to the third party server (TPS) hosting the web site for dailymotion.com, for example, server 40a with the URL www.dailymotion.com. Accordingly, the web page 310 of FIG. 3E is rendered to the browsing application of the computer of the user, this web page 310 on the monitor or display screen 62b of the computer 62 of the user 62a.

FIG. 3F is an alternate embodiment web page 306′, where the listings provided in the Recommended 308a and Paid 308b sections can be shared with other users, when the viewing or browsing user activates (or clicks on) the share hyperlink 312. The share hyperlinks 312 are mapped back to the home server 30 and the clicks are tracked and accounted for in the click accounting module 36. Otherwise, the web page 306′ with the share hyperlinks 312 operates similarly to the web page 306 of FIGS. 3C and 3D (as detailed above).

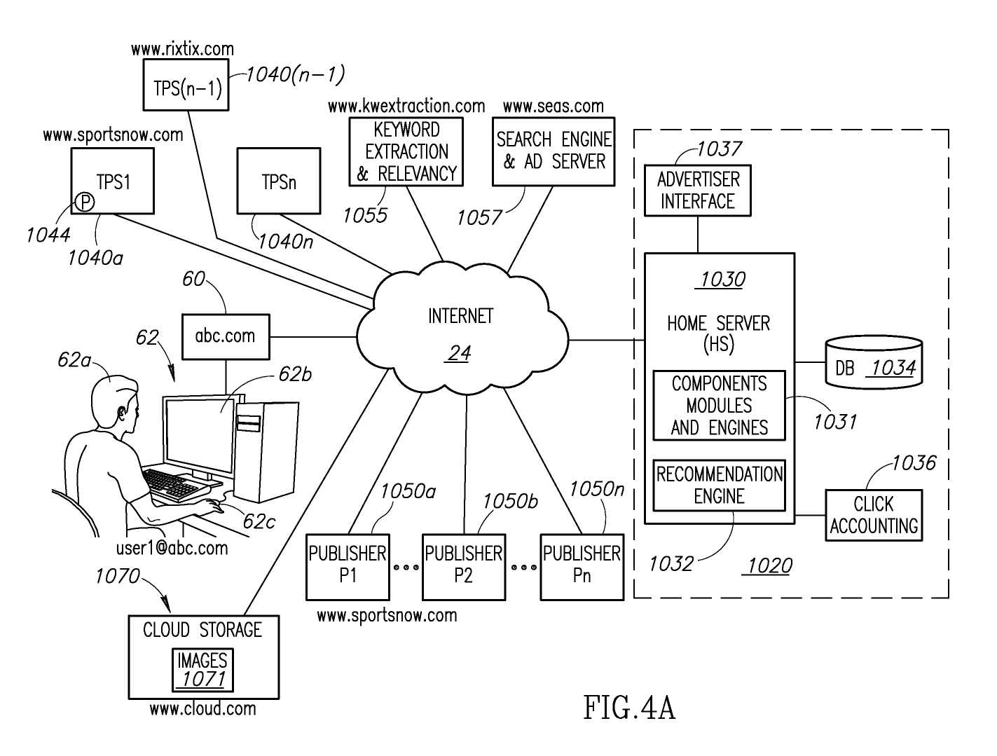

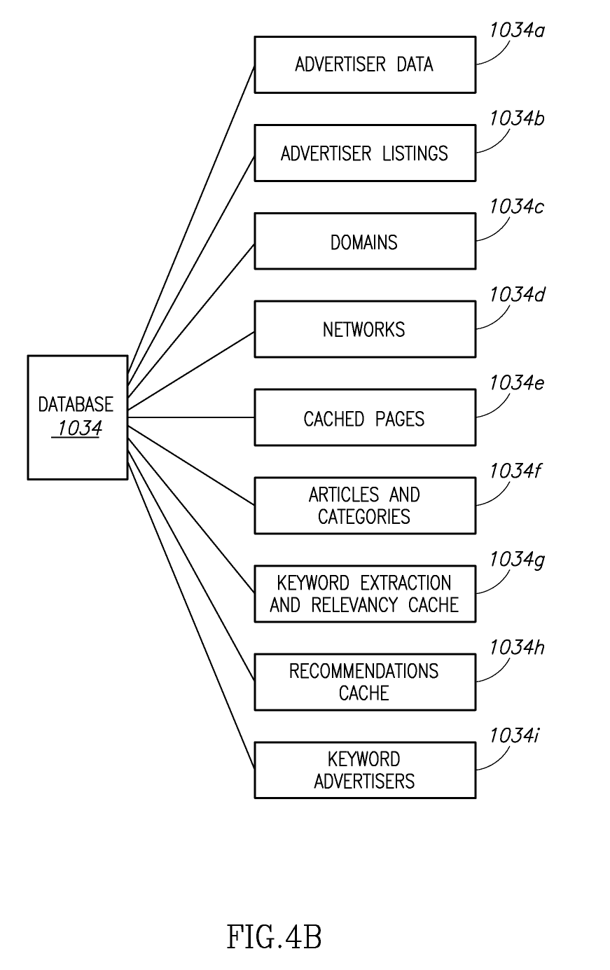

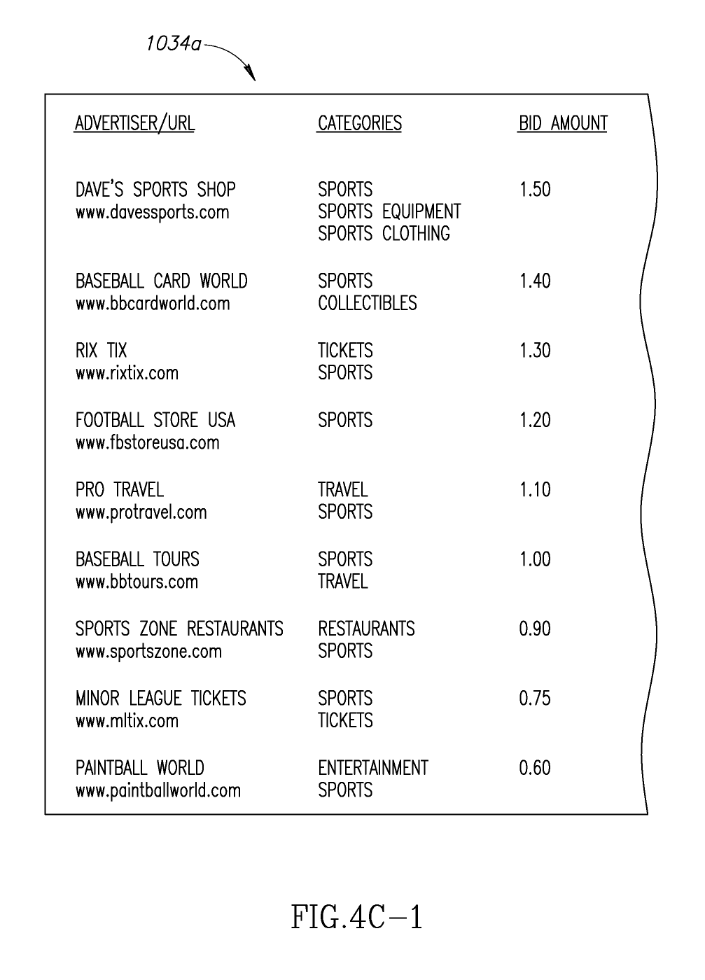

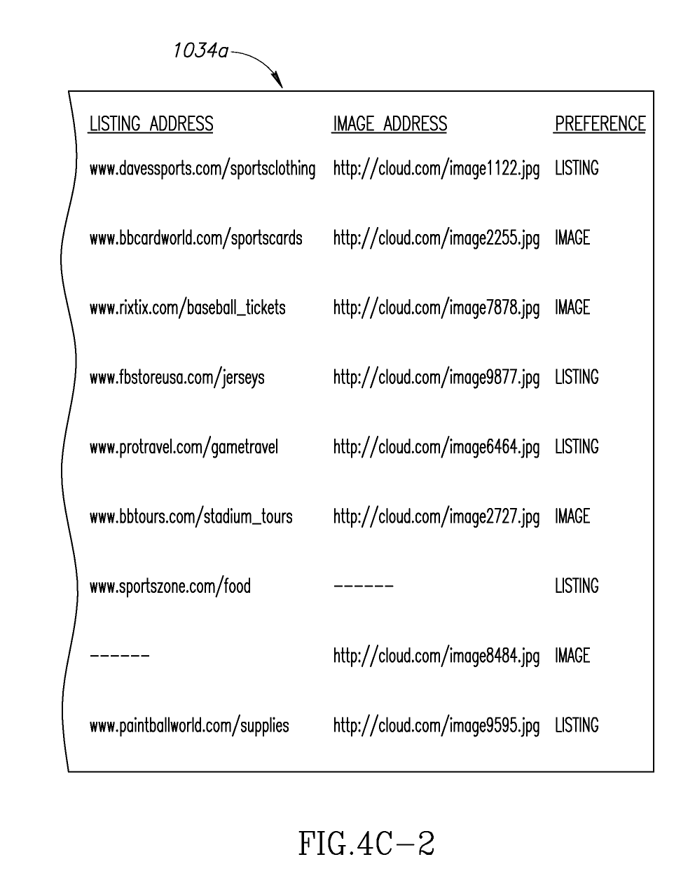

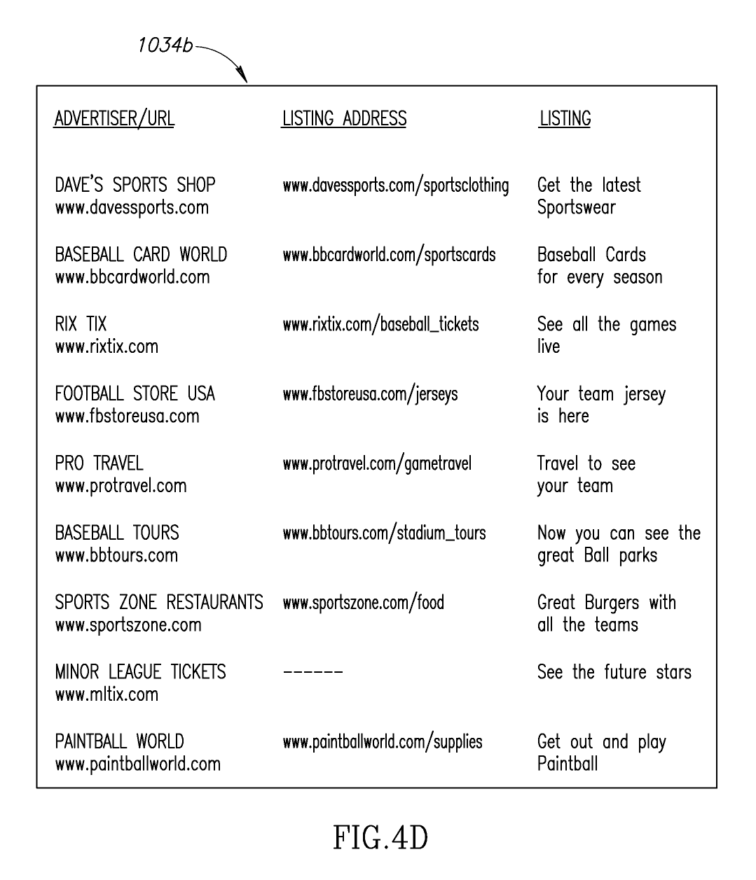

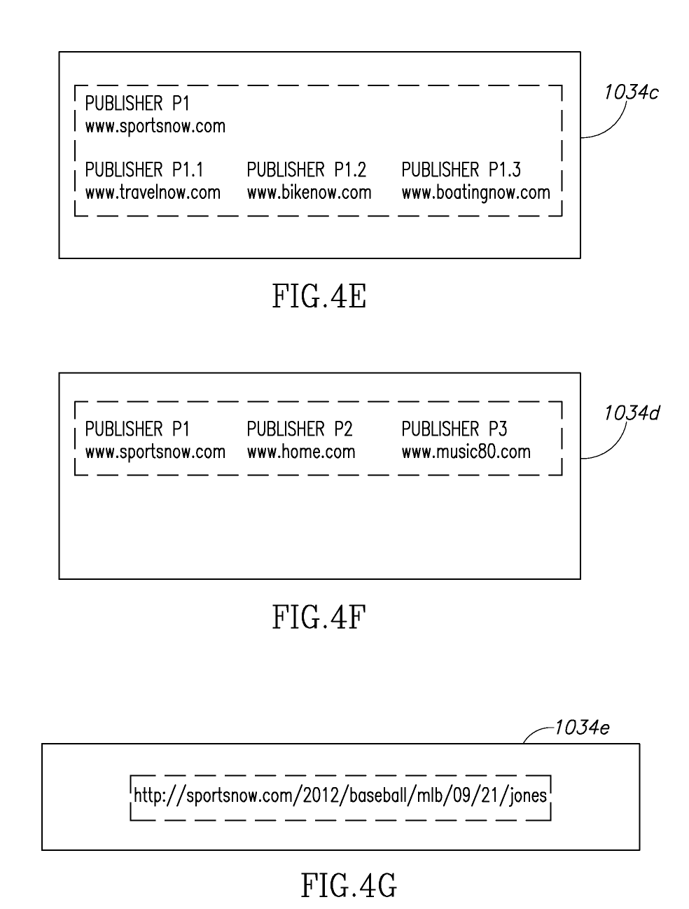

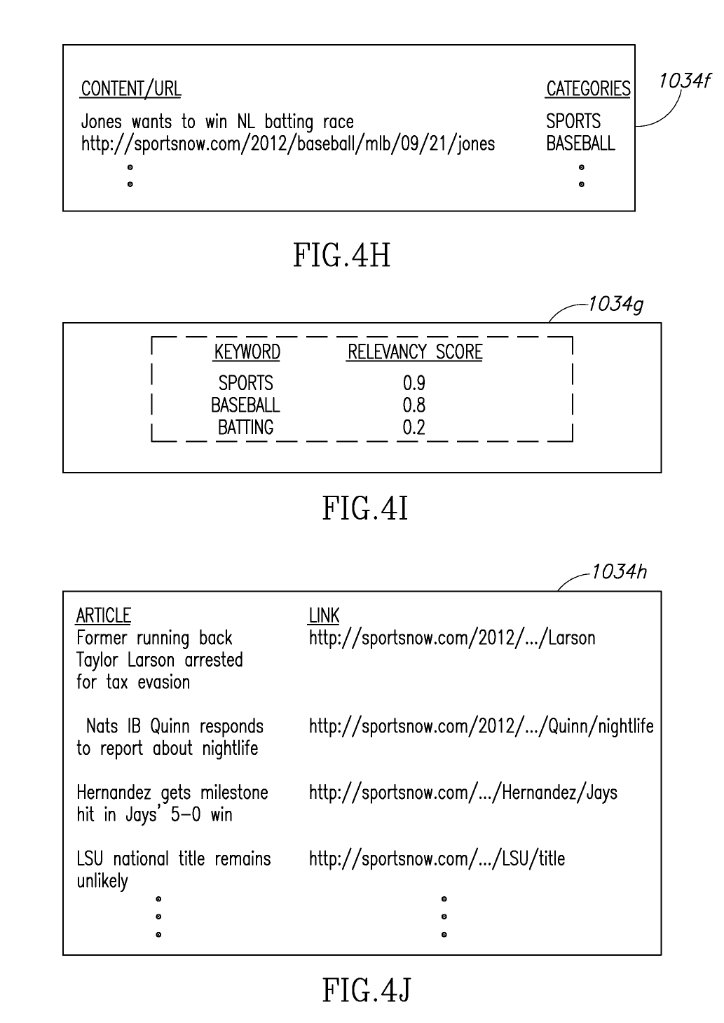

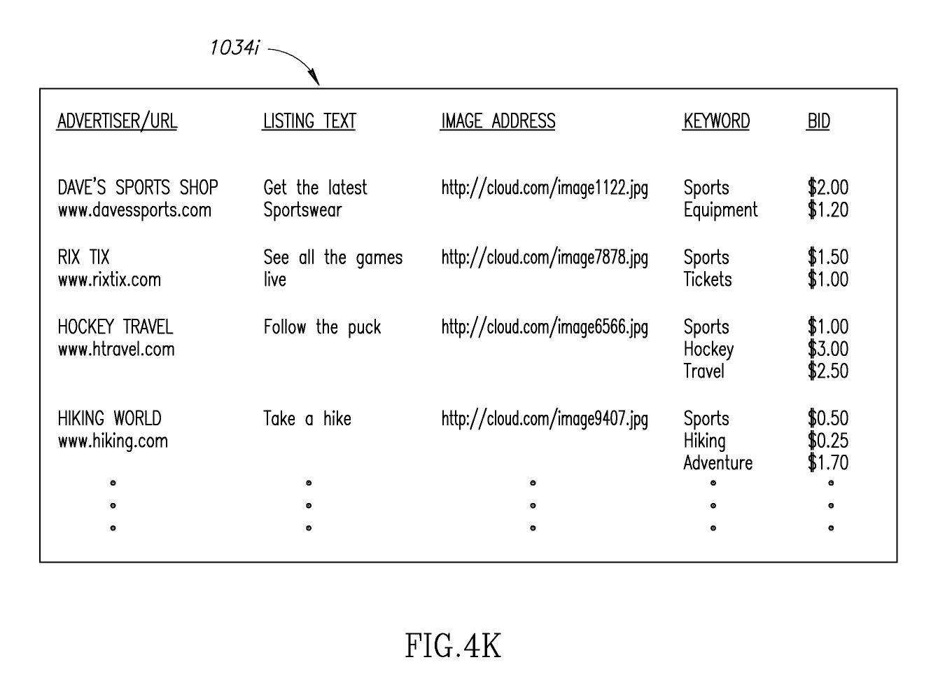

FIGS. 4A-4K show another embodiment of the present disclosed subject matter in an exemplary operation. The present disclosed subject matter employs a system 1020, which is linked, directly or indirectly, wired, wirelessly, or combinations thereof, to a network, including a communications or computer network, such as a wide area network (WAN), that is, for example, a public network, such as the Internet 24. The system 1020 is formed of various servers, server components, computers, computer components, computerized components, machines, workstations and the like, that where similar to the servers, server components, computers, computer components, computerized components, machines, workstations and the like shown in FIG. 1 and described above, and have the same numbering for the similar elements in the “1000's.” The servers, server components, computers, computer components, computerized components, machines, workstations and the like, shown in FIGS. 4A-4K are in accordance with the corresponding elements as disclosed above, with augmentations and differences discussed below.

FIGS. 4A-4K show the present disclosed subject matter in an exemplary operation. The present disclosed subject matter employs a system 1020, which is linked, directly or indirectly, wired, wirelessly, or combinations thereof, to a network, including a communications or computer network, such as a wide area network (WAN), that is, for example, a public network, such as the Internet 24 (as detailed above). The system 1020 is, for example a computer system, formed of various servers, server components, computers, computer components, computerized components, machines, workstations and the like, and includes a home server (HS) 1030, also known as the main server.

The home server 1030 may be, for example, a computer system, including one or more servers, server components, computers, computer components, computerized components, machines, workstations and the like, and are associated with storage media, and processors, including those for executing stored computer components, both internal and external. The home server 1030 may also include computers, machines, computer and computerized devices and/or components (including computer components), processors, storage media, including storage media for storing computer components, modules, engines, and combinations thereof. The home server 1030 is detailed further below.

There are, for example, numerous servers that work in conjunction with the system 1020, and are linked directly or indirectly, wired or wirelessly, or combinations thereof, to the network 24. These servers, for example, include third party servers (TPS1-TPSn) 1040a-1040n, each representative of third parties, such as publishers (P1-Pn), represented by computer systems, which are, for example, content sources, and perform functions including hosting and distributing the respective publisher's content, e.g., electronic content including digital content. These servers further include servers 1050a-1050n, which include administrative servers, advertisers (for example server 1040(n-1) for Rix Tix, an event ticket seller, having the URL www.rixtix.com), and other content providers, typically unrelated to the system 1020. Each publisher 1050a-1050n is typically associated with at least one third party server (TPS) or hosting server 1040a-1040n, which hosts and distributes the publisher's content.

Alternately, the publisher servers 1050a-1050n themselves, for example, can be content sources and can host and distribute the respective publisher's content, e.g. electronic content including digital content. As such, the functions described herein as performed by the third party servers 1040a-1040n, as detailed herein, for the respective publisher are performed by the respective publisher server 1050a-1050n, and the plug-ins mapped to the system 1020 would be at the respective publisher servers 1050a-1050n).

For example, the content of the publisher P1 1050a, Sports Now Magazine, is hosted by the third party server 1040a, which has the URL www.sportsnow.com. Third party servers 1040a-1040n on which plug-ins 1044 (represented by the circled “P”) are applied, the plug-ins 1044 being software which allows the home server 1030 to crawl the web pages, content and the like hosted by the third party server, for example, server 1040a, in order to cache the web page in the web page cache 1034e of the database 1034, associated with the home server 1030 of the system 1020.

There is also a server 1055 for keyword extraction and relevancy determination, with a URL of www.kwextraction.com, representative of servers that extract keywords and perform relevancy determinations from these keywords. This keyword extraction and relevancy server 1055 is, for example, operated by AlchemyAPI™, available from Orchestr8, LLC, 2300 15th Street, Suite 320, Denver, Colo., 80202 (www.alchemyapi.com).

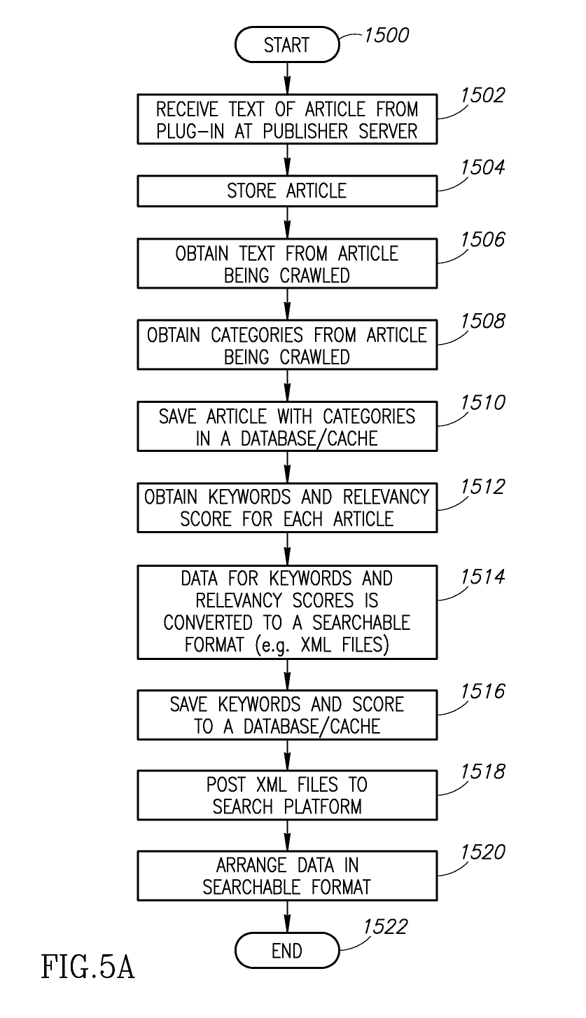

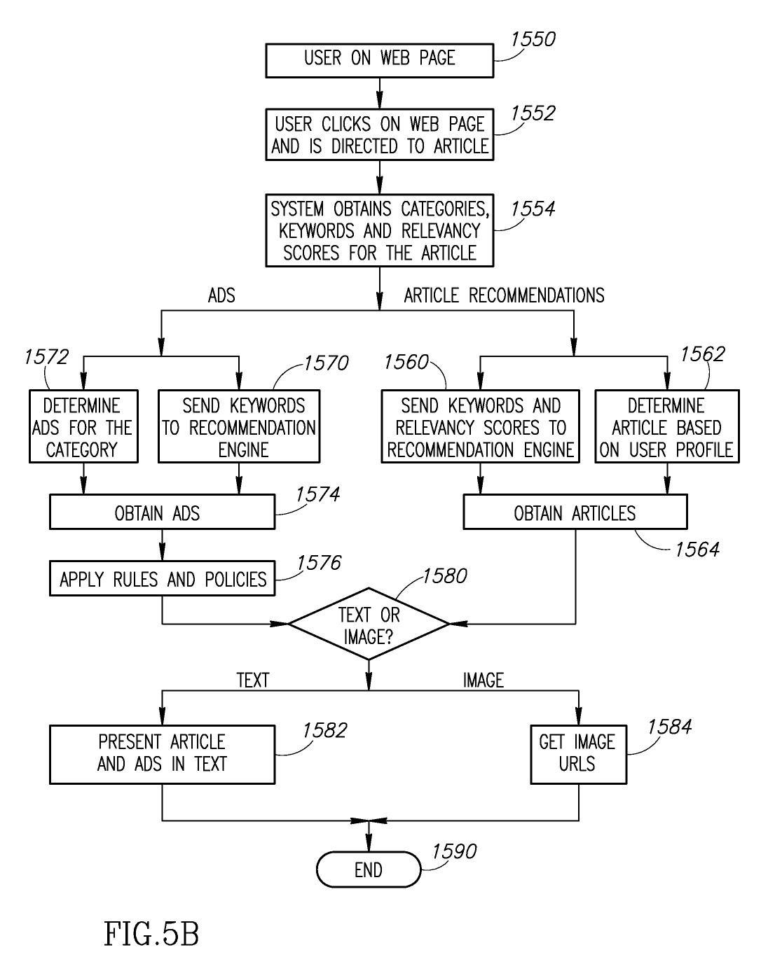

A search engine and advertisement server 1057, with a URL of www.seas.com, representative of search engine servers. One suitable search engine and advertisement server is, for example, provided by Miva (www.miva.com), from Adknowledge, Inc., of Kansas City, Mo., 64112 (www.adknowledge.com). The search engine and advertisement server 1057, for example, combines a search engine and an advertisement server with an inventory of advertisements, for providing advertisements to the system 1020, i.e., the home server 1030, if necessary or requested, for distribution to users (for example, the users represented by the user 62a), as detailed below, as well as applying rules and policies to obtained advertisements, as detailed further below (for example, block 1576 of FIG. 5B).

These aforementioned servers 1055, 1057 may be part of the system 1020. However, these servers 1055, 1057 may also be independent of the system 1020.

There are also domain servers, for example, server 60, which hosts the domain abc.com. This server 60 is representative of a multitude of domain servers linked to the network 24, as detailed above. This server 60 supports a computer 62 of a user 62a, with an e-mail addresses user1@abc.com, which accesses the various servers linked to the network 24, such as the home server 1030, third party servers 1040a-1040n of the publishers (P1-Pn), as well as numerous other servers over the network 24.

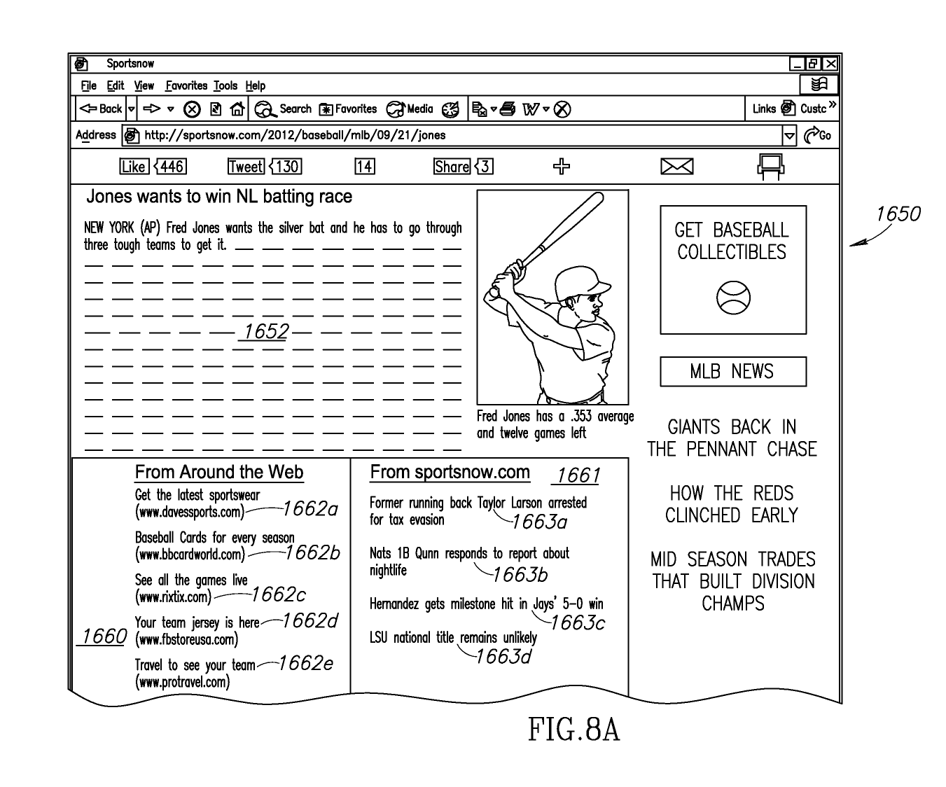

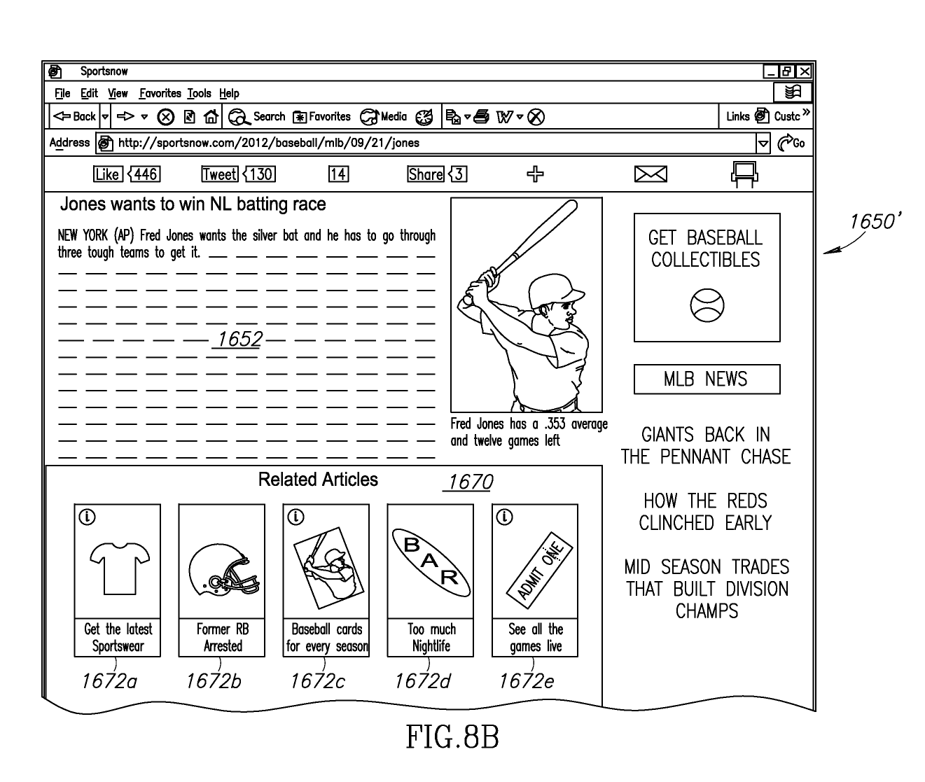

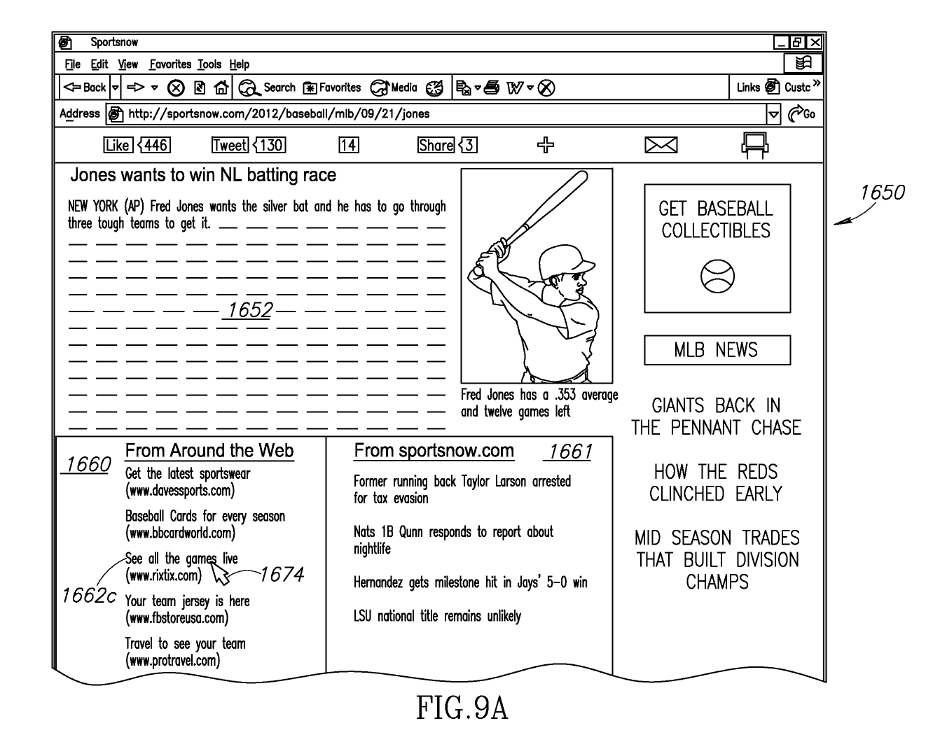

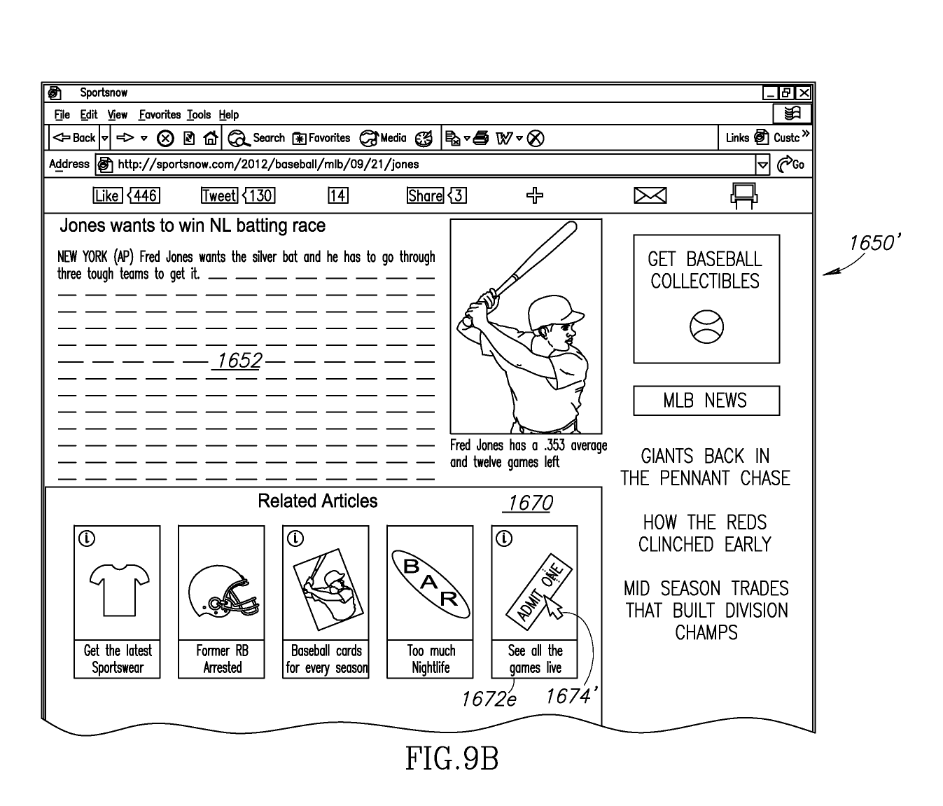

Servers for cloud storage, represented by server 1070, with a URL of www.cloud.com, provide remote storage for the system 1020. For example, the server 1070 includes an image store 1071 for images, for example, thumbnail images (as displayed in FIGS. 8B and 9B), and described below, as well as images corresponding to the advertisers in the keyword advertiser subdatabase 1034i.

The servers (and/or computer systems) 1030, 1040a-1040n, 1050a-1050n, 1055, 1057, 60 and 1070 are linked (either directly or indirectly) to each other and an endless number of other servers and the like, via the network, for example, the Internet 24. These servers 1030, 1040a-1040n, 1050a-1050n, 1055, 1057, 60 and 1070 are arranged along the network 24, so they are in electronic and/or data communication, directly or indirectly, with each other.

The servers 1040a-1040n, 1050a-1050n, 1055, 1057, 60 and 1070, are, for example, computer systems, and include multiple components, including processors, microprocessors, and the like for performing the requisite functions as detailed below, and the components may be based in hardware, software, or combinations thereof. The servers 1040a-1040n, 1050a-1050n, 1055, 1057, 60 and 1070 may also have internal storage media and/or be associated with external storage media, which functions with the server structures and components to perform the server functions detailed herein.

These servers 1040a-1040n, 1050a-1050n, 1055, 1057, 60 and 1070, may be one or more servers, server components, computers, computer components, computerized components, machines, workstations and the like. While various servers have been listed, this is exemplary only, as the present disclosed subject matter can be performed on an endless numbers of servers and associated components, which are in some way linked to a network, such as the Internet 24, both directly and indirectly.

The user 62a, representative of all users of the disclosed subject matter, has (or is associated with) a computer 62 (such as a multimedia personal computer with a Pentium® CPU, that employs a Windows® operating system) that may use an e-mail client. The computer 62 is linked to the Internet 24. The computer 62 includes a monitor or display screen 62b and is operated by an activatable pointer, such as a mouse 62c or the like. The computer 62 includes an e-mail client (detailed above), installed thereon, that provides the user 62a with a unique address and the ability to utilize one or more e-mail addresses. For example, the user 62a has an e-mail address, user1@abc.com, through which he receives his e-mail from the domain server 60, which hosts the domain “abc.com,” of which the user 62a is a member. The computer 62 of the user 62a includes a web browser, browsing software, application, or the like, to access web sites or web pages from various servers and the like, on the Internet 24. Some exemplary web browsers/web browsing software/browsing applications include, Internet Explorer®, from Microsoft, Redmond, Wash., Netscape® Navigator®, and Mozilla Firefox™.

The home server (HS) 1030 is of an architecture that includes one or more components, modules, engines and the like, represented by the box 1031, for providing numerous additional server functions and operations, for example, web page and web site hosting and administration, web page and text crawling for terms, words, content and the like, from web pages, such as those containing articles, advertising and the like, text parsing (for example, stripping out HTML (Hypertext Markup Language)), natural language processing, keyword and text extraction, for example, from web pages, such as those containing articles, advertising and the like, URL designation, drafting text for articles or listings for articles, and advertisements based on the crawled content and parsed text of articles or content or information items (for example, to accompany images for links to the articles, content or information items and advertisements), linking to additional servers over the network 24, creating data, including links, the data which is activatable to access the content associated with the data, including the link, on the network 24, policy and/or rules processing, comparison and matching functions, various search and other operational engines, browser directing and redirecting functions, data sending, storing and receiving, providing text to images for display (for example, FIG. 8A) when images from the image store 1071 of the cloud storage 1070, and the like. The one or more components, modules, engines and the like, represented by the box 1031, may be based in hardware, software, or combinations thereof.

The home server (HS) 1030 includes various processors, including microprocessors, for performing the functions and operations detailed herein, and storage media, for example, the database 1034, either internal or associated therewith, operable with the server components, modules, engines and the like. The home server (HS) 1030 may be associated with additional caches, databases, as well as numerous other additional storage media, both internal and external thereto, for temporary and permanent storage. For explanation purposes, the home server (HS) 1030 may have a uniform resource locator (URL) of, for example, www.homeserver.com.

The home server (HS) 1030 includes a recommendation engine 1032 that utilizes a search platform, for providing articles, items of content and information, for presentation to users, such as user 62a. The search platform is configured for searching databases, such as database 1034 (including its subdatabases and caches), storage media, etc. (of the home server 1030) and publisher databases (associated with the publisher computer systems, administration computer systems 1050a-1050n and servers 1040a-1040n, for listings, content, categories, keywords and search terms (which result in recommendations for content on the web page being viewed). For example, one suitable search platform is SOLR, from The Apache Software Foundation of 1901 Munsey Drive, Forest Hill, Md. 21050-2747, (http://lucene.appache.org/solr/).

The database (DB) 1034 of the home server 1030, is shown in FIG. 4B, as a single database with subdatabases and/or caches 1034a-1034i linked together, but can also be multiple databases and/or caches. The database (DB) 1034 shown includes the multiple subdatabases and caches 1034a-1034i. Multiple other subdatabases and caches are also permissible with the database 1034, but are not shown. These subdatabases and caches include a subdatabase for Advertiser Data 1034a, including, for example, URLs of the third party servers 1040a-1040n hosting the advertiser's content and, accordingly, are associated with the advertiser, listing texts, listing addresses, categories and/or other search terms, and monetary bid amounts for the category or other search term, associated with the particular advertiser.

This advertiser data subdatabase 1034a is shown, for example, in FIGS. 4C-1 (left side of the subdatabase 1034a) and 4C-2 (right side of the subdatabase 1034a). This subdatabase 1034a stores advertiser data, received at least in part through the advertiser interface 1037. The advertiser data stored in this subdatabase 1034a includes, for example, the advertiser name ad URL (for the third party server 1040a-1040n associated with the advertiser's content), one or more categories, a bid amount (monetary, for example in US Dollars), an address in the system or over the network of the storage media in which the actual listing for the advertiser is stored, including temporary storage, an address in the system or over the network of the storage media in which the image (for example, a thumbnail image) for the advertiser is stored, including temporary storage, an advertiser's preference for a listing or an image to be displayed to computer monitors of users, when the advertiser is selected for display to the users, such as the user 62a.

A subdatabase for Advertiser Listings 1034b, includes the actual listings to be displayed, and is shown, for example, in FIG. 4D.

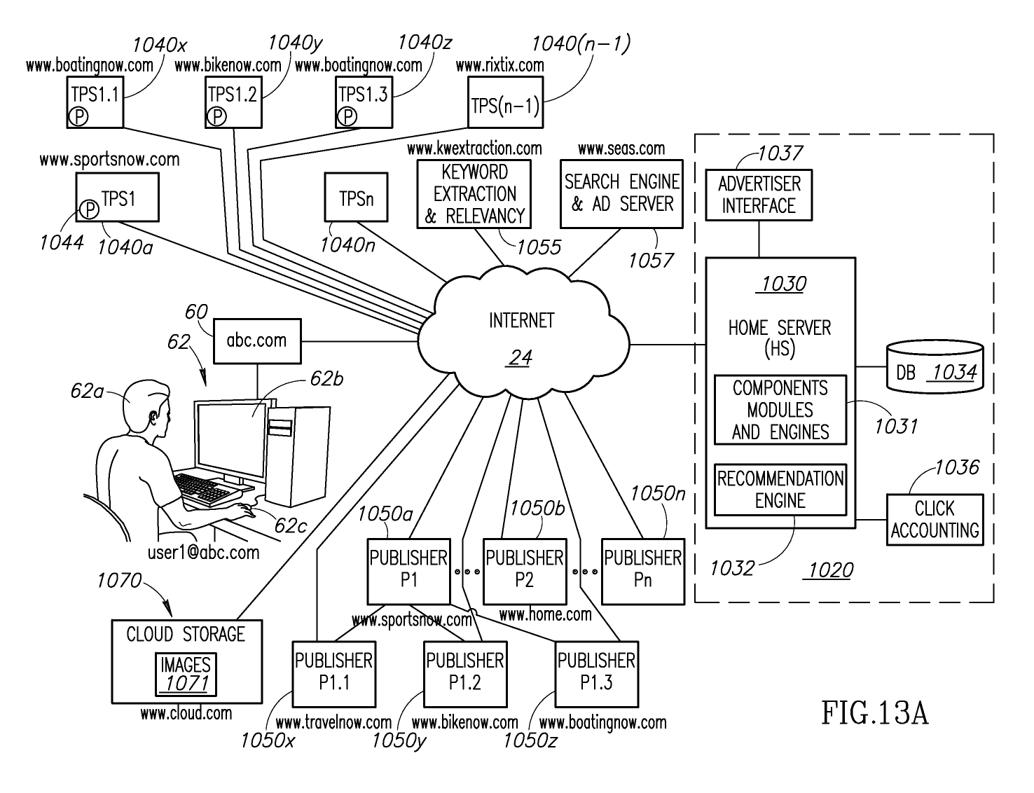

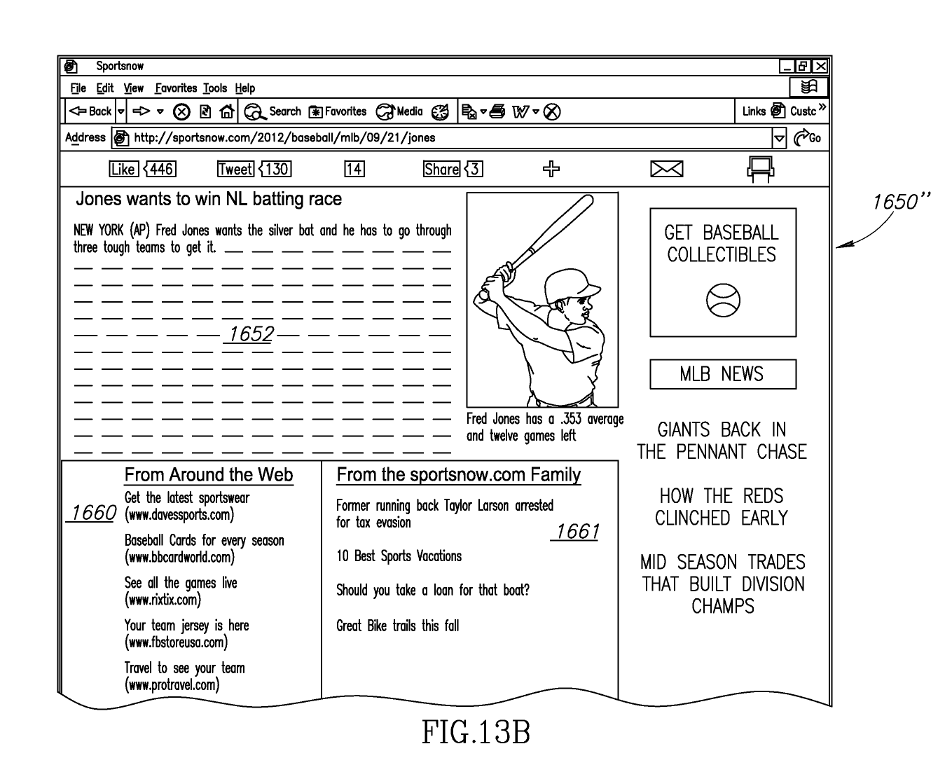

FIG. 4E is a subdatabase 1034c, for publisher domains, established by the publisher, for example, publisher P1 Sports Now Magazine, and reported to the system 1020, who administers the domain. The publisher domain shown in the broken line box of FIG. 4E is that for the publisher P1, Sports Now Magazine, with the URL, www.sportsnow.com. This domain is formed of Publisher P1-Sports Now Magazine, Publisher P1.1 Travel Now Magazine (www.travelnow.com), Publisher P1.2 Bike Now Magazine (www.bikenow.com), and Publisher P1.3 Boating Now Magazine (www.boatingnow.com), and is further illustrated and described in FIG. 13A, below. Domains are typically associated with the same entity.

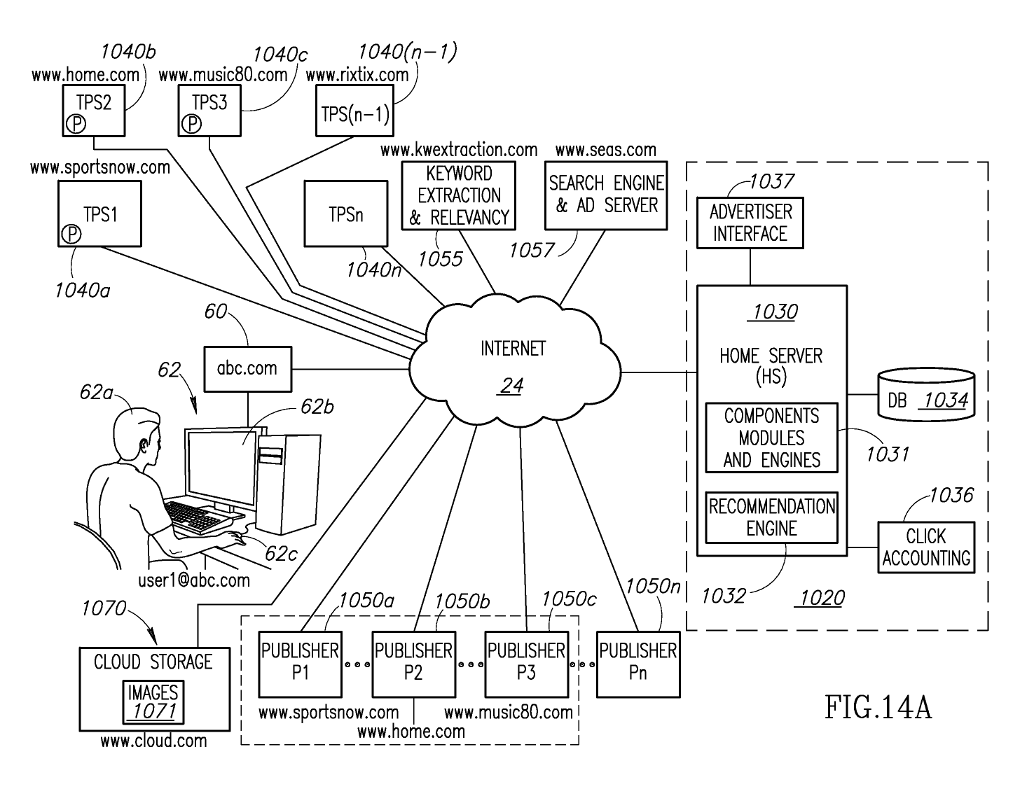

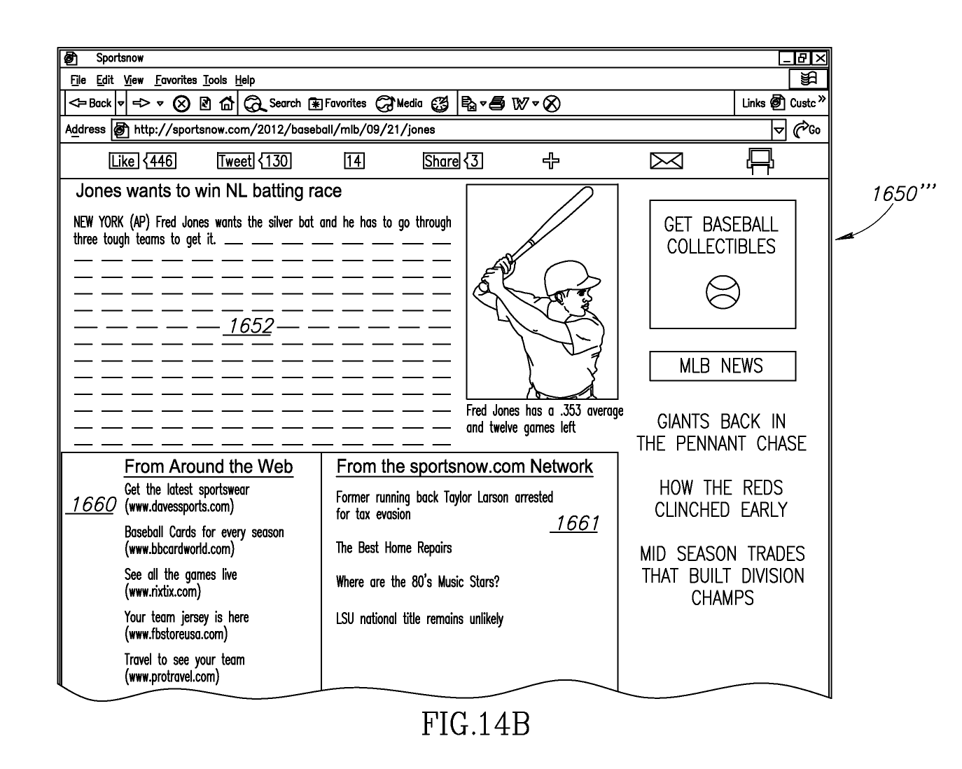

FIG. 4F is a subdatabase 1034d, for publisher networks, established and administered by the system 1020. The publisher network shown in the broken line box of FIG. 4F is that for the publisher P1 Sports Now Magazine, with the URL, www.sportsnow.com. This network is formed of Publisher P1-Sports Now Magazine, Publisher P2 Home Magazine (www.home.com), and Publisher P3 80's Music (www.music80.com). This network is further illustrated and described in FIG. 14A, below. The publishers of the network are typically associated with different entities.

There is a cache for web pages 1034e, as shown in FIG. 4G, including web pages and/or articles and other content, which has been, and is constantly being taken from, the World Wide Web (WWW) by crawling applications, engines and modules of the home server 1030. The web pages, in particular the articles and content therefrom, are obtained and cached, for example, in real time, and typically before the user, such as the user 62a, has accessed the requisite publisher's web site. As shown in the broken line box of FIG. 4G, the article 1652 of FIGS. 8A, 8B, 9A and 9B is stored in the cache 1034e by its URL.

FIG. 4H shows a cache 1034f for the articles or other content and information items which have been cached, as associated with categories, assigned by the system 1020. For example, the article 1052, as displayed in FIG. 8A, for example, is shown in this cache 1034f.

cache 1034g for storing the resultant extracted keywords and relevancy score for each article, item of content, information or advertisement, as extracted by the keyword extraction and relevancy server 1055 is also provided, and is shown in FIG. 41. For example, shown are the extracted keywords and relevancy scores for each keyword for the article “Jones wants to win NL batting race”, with its corresponding URL http://sportsow.com/2012/baseball/mlb/09/21/jones, which is displayed, for example, in FIG. 8A as an article 1652 (on web page 1650).

FIG. 4J shows the Recommendations cache 1034h, for storing recommended articles, content and information items, as obtained by the Recommendations Engine 1032. For example, the articles shown, along with their corresponding links (or URLs), for example, as a group or list, are those shown from a search of the content of Publisher P1 Sports Now Magazine, as hosted on the corresponding third party server 1040a of Publisher P1. This group or list is discussed further with respect to FIGS. 8A and 9A, below.

FIG. 4K shows a subdatabase 1034i for keyword advertisers, such as that used in pay per click (PPC), also known as cost per click (CPC) advertising. Advertisers typically enter data, which is stored in this subdatabase 1034i via the advertiser interface 1037. The advertiser data includes, for example, the advertiser's name and URL, text for the advertisement when displayed as a listing to users, such as in search results, an address for the corresponding image, for example in the image store 1071 of the cloud storage 1070, keywords, and bids for the keyword (in monetary amounts such as in U.S. Dollars). As shown, the advertisers are in bid order for the keyword “sports.”

While a single home server (HS) 1030 is shown, the home server (HS) 1030 may be formed of multiple servers, computers, machines, computer and computerized devices and/or components, processors, storage media, modules, engines, and the like.

The system 1020 also includes a module 1036 for click accounting, for example, performing functions such as tracking and mapping clicks, administering pay per click or pay for performance amounts in advertiser accounts, crediting (increasing an advertiser's balance) and debiting (for example, subtracting an amount for each click, conversion, or other event associated with an advertisement, article, item of content or information) advertisers accounts, administering payments and credits to the system 1020 and third parties, and the like.

An advertiser interface 1037 is also linked to the home server 1030. The advertiser interface serves to receive data from advertisers, to be used by the home server 1030. The advertiser data includes, for example, the advertiser's URL (for example, for the third party server (TPS) 1040a-1040n), listing text, listing address, graphic (to be provided to the cloud server 1070), category, keyword or other search terms and monetary bid amount. Category based advertiser data is stored in subdatabase 1034a, while keyword based advertiser data is stored in the subdatabase 1034i. While the advertiser interface is shown as part of the system 1020, it may be outside the system 1020.

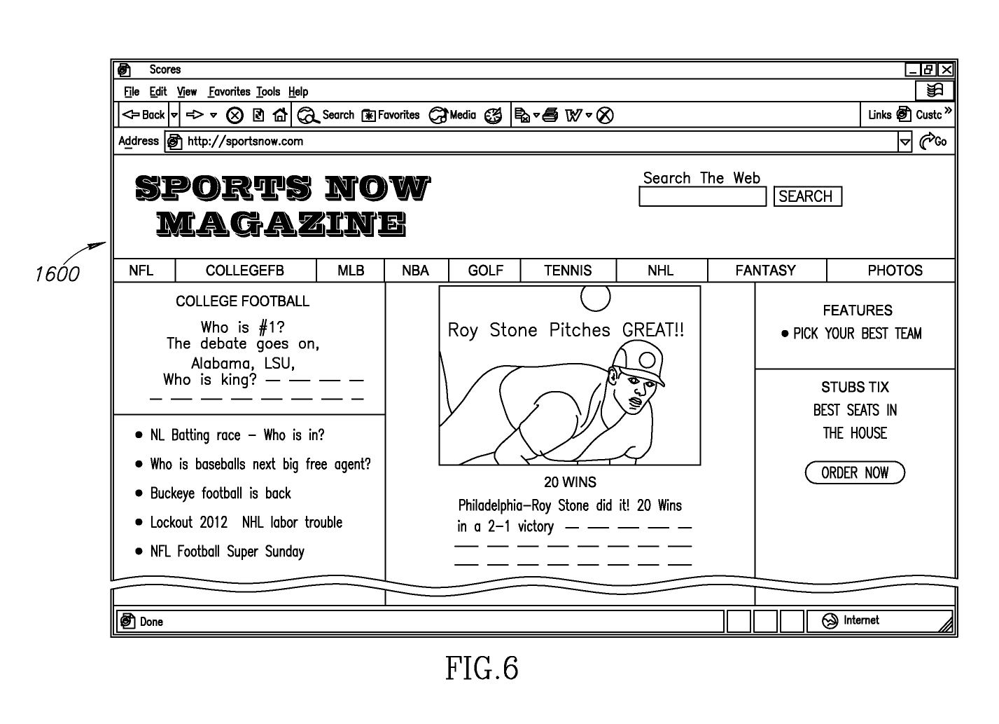

Turning also to FIG. 5A and 5B, there are shown exemplary implementations of processes or methods, hereinafter “processes,” in accordance with embodiments of the disclosed subject matter. FIGS. 5A and 5B are flow diagrams of the processes (methods), for obtaining and selecting listings based on the web page, for example, the text of an article or text being viewed by the user, the web page/web site to which the browsing application of the computer of the user is directed. FIGS. 6, 7, 8A and 8b are screen diagrams or screen shots, which appear on the monitor or display screen of the computer of the user, during the processes of FIGS. 5A and 5B.

The process starts at block 1500. The system 1020 has typically received all articles, items of content and information from the publisher server 1040a of publisher P1 by virtue of the plug-in 1044 (FIG. 4A) being installed thereon, at block 1502. The plug-in 1044 causes the publisher server 1040a to send the articles, items of content and information to the system 1020. The articles, items of content and information are stored (cached) in the cache 1034e, at block 1504. For example, the article “Jones wants to win NL batting race” 1652, of web page 1650 of FIG. 8A is one such received article which is cached. The processes and methods applied to or associated with this article 1652 are now described, to illustrate the methods and processes of the disclosed subject matter.

The article 1652 of the web page 1650 is crawled and the text is parsed (including for example, stripping out HTML) by the home server 1030, components modules and engines 1031 to obtain text, at block 1506. From this crawl and parsing of the text, categories are obtained for the article, at block 1508, and the categories with the corresponding article, i.e., the article “Jones wants to win NL batting race” 1652, of web page 1650 of FIG. 8A, is stored in the cache 1034f, at block 1510.

The parsed text is sent to the server 1055, with, for example, the URL www.kwextraction.com, where keywords, search terms, or other relevant text, phrases or the like (collectively “keywords”), in natural language, are obtained, and isolated, and assigned relevancy scores, as block 1512. This keyword extraction and relevancy server 1055 is, for example, operated by AlchemyAPI™, available from Orchestr8, LLC, 2300 15th Street, Suite 320, Denver, Colo., 80202 (www.alchemyapi.com).

The process moves to block 1514, where extracted keywords and relevancy scores (in the form of data) are sent to home server 1030. The home server 1030 converts or places the data for the aforementioned extracted keywords and relevancy scores into a searchable format. For example, the home server 1030 formats the extracted keywords and relevancy scores by creating XML files of the data for the extracted keywords and relevancy scores, based on a predetermined schema for a search platform. For example, one search platform used is SOLR, from The Apache Software Foundation of 1901 Munsey Drive, Forest Hill, Md. 21050-2747, (http://lucene.appache.org/solr/). The home server 1030 may employ its temporary storage media during this process.

The extracted keywords and relevancy scores, in the desired searchable format, for example, XML (Extensible Markup Language), are stored in the cache or subdatabase of the home server 1030, for example, cache 1034g, at block 1516. The converted data, for example, the XML files created at block 1514, are posted to a searchable platform (e.g., SOLR), at block 1518. The data, e.g., the data from the XML files, is arranged in a searchable format using an algorithm, at block 1520. For example, one such algorithm is Lucene, available from The Apache Software Foundation of 1901 Munsey Drive, Forest Hill, Md. 21050-2747, http://lucene.apache.org, which runs on the home server 1030 or a server associated with the home server 1030 and/or the system 1020. This first process ends at block 1522.

This first process, including the processes detailed on blocks 1500, 1502, 1504, 1506, 1508, 1510, 1512, 1514, 1516, 1518, 1520 and 1522, for example, typically occurs prior to the web pages (or electronic pages) 1600 and 1650 being rendered to the browsing application of the computer 62 of the requesting user 62a. The processes of blocks 1506 to 1520 (and 1522) are, for example, performed automatically, and in real time. From block 1514 onward, the processes are typically performed one after the other.

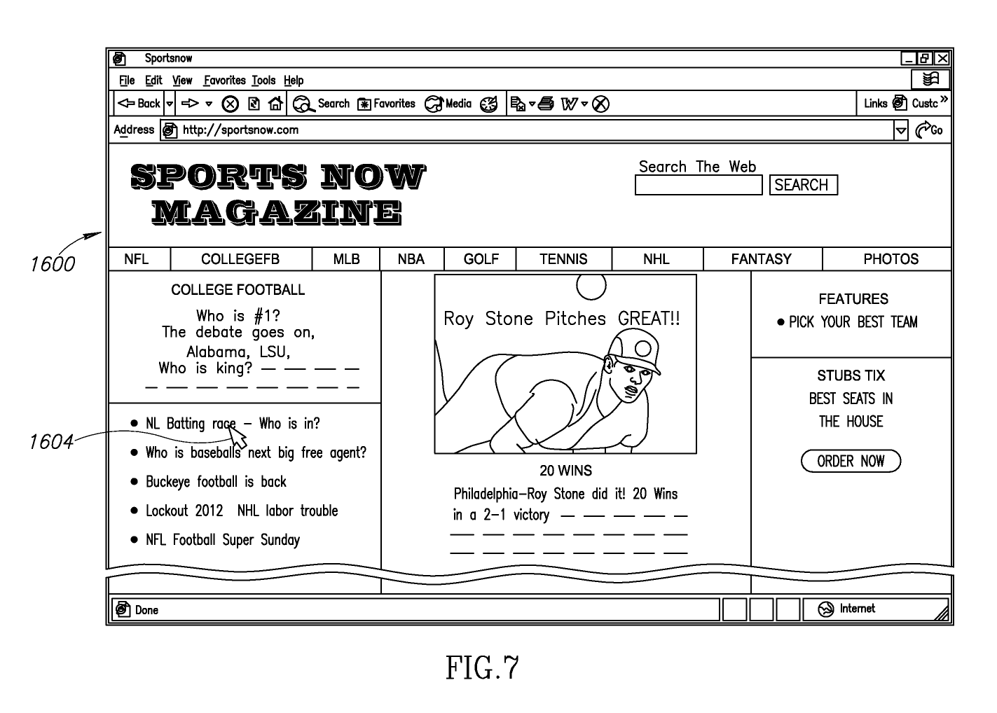

Directing attention to FIG. 5B, the second process starts at block 1550, as the user is on the web page 1600 of FIG. 6. The user 62a now sees (via his monitor or display screen 62b) the web page 1600 of FIG. 6, as the browser associated with the user's computer 62 is directed to the URL www.sportsnow.com (for example, hosted by the publisher server P1 1040a). The user 62a, then clicks (with his mouse 62c), the click indicated by the arrow 1604 on the text “NL Batting Race—Who is in?” at FIG. 7. The text, “NL Batting Race—Who is in?,” is hyperlinked to the publisher server, for example, publisher server 1040a for publisher P1, www.sportsnow.com, and the user's browsing application is directed to the corresponding URL for this article, e.g., http://sportsow.com/2012/baseball/mlb/09/21/jones, which displays as the article entitled: “Jones wants to win NL batting race,” 1652 (FIG. 8A), at block 1552.

From the article 1652 of web page 1650 having been crawled and the text parsed, as detailed above, the home server 1030 pulls the categories associated with this article, from cache 1034f, and keywords and relevancy scores from the cache 1034g, at block 1554. From this point, article recommendations will be made by the recommendation engine 1032, applying the search platform, for example, SOLR, as detailed above, to the keywords and relevancy scores, and the content of the publisher P1, as associated with the P1 publisher server 1040a. Articles (including content and information items) are then provided to the system 1020 and stored as a group or list, either in a random order, or other order, based on rules and policies of the home server 1030, in the cache 1034h, at block 1564. The articles are stored in the cache 1034h (FIG. 4J) in the form of representative data, the representative data including for example, a listing or title for the article, and a link to the article.

Alternately, articles (including content and information items) may be selected from the publisher server P1 1040a, based on “behavioral targeting” of the user 62a. In “behavioral targeting,” user browsing behaviors are collected and applied to the specific user 62a, based on that user's specific browsing behavior, to generate a group (list) of articles, at block 1562. The “behavioral targeting” process is disclosed, for example, in commonly owned U.S. patent application Ser. No. 11/449,306, entitled: SYSTEM AND METHOD FOR BEHAVIORALLY TARGETING ELECTRONIC COMMUNICATIONS, and published as U.S. Patent Application Publication No. US 20070288298 A1, and Ser. No. 11/774,066, entitled: SYSTEM AND METHOD FOR BEHAVIORALLY TARGETED ELECTRONIC COMMUNICATIONS, published as U.S. Patent Application Publication No. US 20070288304 A1, the disclosures of both patent applications incorporated by reference in their entirety herein. Articles (including content and information items) are then provided to the system 1020 and stored as a group or list, either in a random order, or other order, based on rules and policies of the home server 1030, and stored in a cache (not shown) as representative data, similar to that for the cache 1034h, at block 1564.

For each click causing a browser redirection to the article entitled: “Jones wants to win NL batting race,” 1652 (FIG. 8A), and the URL http://sportsnow.com/2012/baseball/mlb/09/21/jones, the click, which is mapped to the system 1020, can be sent toward the process of either block 1560 or block 1562, either randomly or in accordance with any order determined by rules and policies of the system 1020. The process can be triggered also by users, for example, user 62a requesting the URL, i.e., http://sportsnow.com/2012/baseball/mlb/09/21/jones, directly from the browser associated with his computer 62. Articles may also be combinations of the processes of blocks 1560 or 1562.

Additionally, the processes of blocks 1560, 1562 and 1564 are typically performed automatically and in real time.

To provide the advertisements (ads) for the web page 1650 that supports the article 1652, the process moves to blocks 1570 and 1572. At block 1570, keywords associated with the selected article, “Jones wants to win NL batting race,” from the cache 1034g, are pulled by the recommendation engine 1032, and applying the search platform, for example, SOLR, as detailed above, to the keywords, ads are selected from the keyword advertisers database 1034i, where these advertisements have been stored as representative data, including the advertiser and its URL, listing text for the advertiser, image address for the advertiser, and keyword(s) and bids (for each keyword), for the advertiser. Advertisements are then provided to the system 1020, either in a random order, or other order, based on rules and policies of the home server 1030, at block 1574. The obtained advertisements from block 1574 can, for example, be stored as a group or list in a cache (not shown), or temporary storage in the system 1020 associated with the home server 1030.

Alternately, at block 1572, one or more, but typically one, category corresponding to the article, i.e., “Jones wants to win NL batting race,” is selected from the cache 1034f (FIG. 4H). A predetermined number of advertisements (e.g., for the number of positions accompanying the article 1652, as supported by the web page 1650, for example, five advertisements for the five positions) for the category, i.e. “sports,” are selected from the subdatabase 1034a. The selected advertisements are obtained from the subdatabase 1034a, in any desired order, for example, based on the highest bid amount, at block 1574. If selected for example, from the subdatabase 1034a based on bid amount, the five advertisers would be, Dave's Sports Shop, Baseball Card World, Rix Tix, Football Store USA, and Pro Travel, based on bid amounts (for example, highest to lowest, as shown). The obtained advertisements from block 1574 can, for example, be stored as a group or list in a cache (not shown), or temporary storage in the system 1020 associated with the home server 1030.

With the ads now obtained, the process moves to block 1576, where rules and policies are applied to the group (list) of obtained ads. The groups are sent to the server 1057, which checks the ads, so that they can be shown, for example applying filters for pornography, language (English, German, Spanish, etc.), age appropriateness, duplicity, etc.

For each click causing a browser redirection to the article entitled: “Jones wants to win NL batting race,” 1652 (FIG. 8A), and the URL http://sportsnow.com/2012/baseball/mlb/09/21/jones, the click, which is mapped to the system 1020, can be sent toward the process of either block 1570 or block 1572, either randomly or in accordance with any order determined by rules and policies of the system 1020. Advertisements may also be combinations of the processes of blocks 1570 or 1572. Additionally, the processes of blocks 1570, 1572, 1574 and 1576 are typically performed automatically and in real time.

The process moves to block 1580, where it is decided if the advertisements and articles will appear as text or images. If text, the process moves to block 1582, where the present list of advertisements and articles fills the number of positions in the areas 1660 (under the heading “From Around the Web”) for advertisements, and 1661 (under the heading “From sportsnow.com”) for articles, on the web page 1650, as shown in FIG. 8.

For example, as shown in FIG. 8A, there are five positions for advertisements 1662a-1662e, and four positions for articles 1663a-1663d. The advertisement listings, representative of the advertisements, are placed in positions 1662a-1662e of area 1660, while article listings, representative of the articles, are placed in positions 1663a-1663d, of area 1661 of the web page 1660. It is this web page which is displayed on the monitor 62c of the computer 62 of the user 62a. The advertisement listings and article listings overlie data, including, for example, hyperlinks or links, the data created the home server 1030. The requisite articles and advertisements can be accessed (for example, by the computer 62 of the user 62a), when the data is activated, for example, by a mouse click or the like, as detailed below. This activation of the activatable data is such that browsing applications, including those associated with computers of users, are directed to the respective advertiser URL and web page or web site, or article URL and web page.

The listings for the advertiser area 1660, under the heading “From Around the Web,” are the advertisers from subdatabase 1034a, from the “sports” category, Dave's Sports Shop (Listing-“Get the latest Sportswear”) 1662a, Baseball Card World (Listing-“Baseball Cards for every season”) 1662b, Rix Tix (Listing-“See all the games live”) 1662c, Football Store USA (“Listing-Your team jersey is here”) 1662d, and Pro Travel (Listing-“Travel to see your team”) 1662e. The listings for the advertiser area 1661, under the heading “From sportsnow.com,” are the articles provided by the recommendation engine 1032 and stored in the Recommendations cache 1034h. These articles are “Former running back Taylor Larson arrested for tax evasion” 1663a, “Nats 1B Quinn responds to report about nightlife,” 1663b, “Hernandez gets milestone hit in Jays' 5-0 win” 1663c, and LSU national title remains unlikely” 1663d.

With the advertisements and articles placed in the web pages and overlying the hyperlinks or links, that when activated direct the user's browsing application to the respective advertiser URL and web page or web site, or article URL and web page, the process ends at block 1590.

Moving back to block 1580, should images be desired for the advertisement and article listings, the process moves to block 1584. The process of block 1584 involves the selected advertisements (list thereof) and selected articles (list thereof) all have corresponding images in the image store 1471 of the cloud storage 1470. The requisite images and text are obtained, so that the web page 1650′ of FIG. 8B is suitable for display on the monitor 62b of the computer 62 of the user 62a.

For the web page 1650′ of FIG. 8B, the text for (or representative of) the advertisements is taken from the subdatabase 1034a, while the text for (or representative of) the articles (the articles having been obtained by the recommendation engine 1032 and stored in the cache 1034h, as per blocks 1560 and 1564 of FIG. 5B and detailed above) is created by the components, modules and engines 1031 of the home server 1030. Each image for (or representative of) each advertisement and/or each article (or item of content or information) is pulled from the image store 1071 (for example, by the components, modules and engines 1031), and corresponding text is placed on the web page 1650′ in an area 1670 under the article 1652, in one of the predetermined positions. For example, web page 1650′ of FIG. 8B has five predetermined positions 1672a-1672e. These positions are filled by an advertisement (indicated by a circled “i”) for Dave's Sports Shop (Listing-“Get the latest sportswear”) 1672a, an article with text “Former RB Arrested” corresponding to the article in the cache 1034h “Former running back Taylor Larson arrested for tax evasion” 1672b, an advertisement (indicated by a circled “i”) for Baseball Card World (Listing-“Baseball Cards for every season”) 1672c, an article with text “Too much nightlife” corresponding to the article in the cache 1034h “Nats 1B Quinn responds to report about nightlife” 1672d, and an advertisement (indicated by a circled “i”) for Rix Tix (Listing-“See all the games live”) 1672e. The advertisement images and article images, as well as their corresponding text (text portion), overlie data, including, for example, hyperlinks or links, the data created the home server 1030. The requisite articles and advertisements can be accessed (for example, by the computer 62 of the user 62a), when the data is activated, for example, by a mouse click or the like, as detailed below. This activation of the activatable data is such that browsing applications, including those associated with computers of users, are directed to the respective advertiser URL and web page or web site, or article URL and web page.

The process ends at block 1590, with the web page 1650′ of FIG. 8B displayed on the monitor 62c of the user 62a. Additionally, the processes of blocks 1580, 1582, 1584 and 1590 are typically performed automatically and in real time.

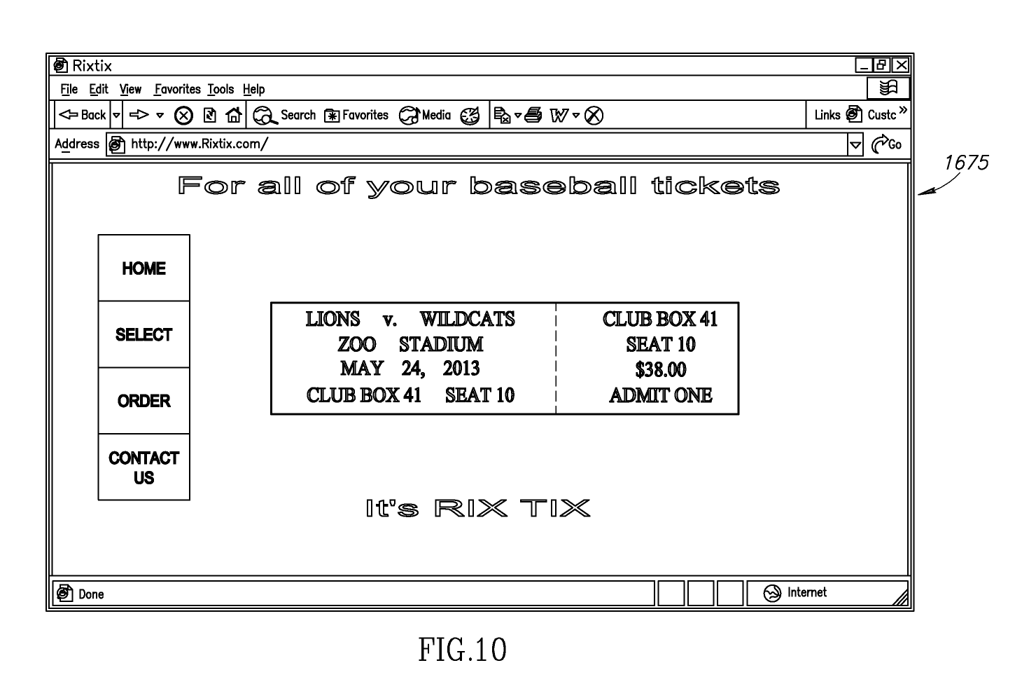

For example, turning to FIGS. 9A and 9B on web pages 1650 and 1650′ should the listing for Rix Tix 1662c (FIG. 9A), or the image (and text) 1672e for Rix Tix (FIG. 9B) be clicked on, as indicated by the arrows 1674 (FIG. 9A) 1674′ (FIG. 9B), the browser of the user 62a will be directed to the URL www.rixtix.com, hosted by the third party server 1040(n-1) which hosts the web site corresponding to the URL www.rixtix.com. The user 62c will see the corresponding web page 1675, shown in FIG. 10, which is displayed on his monitor 62b.

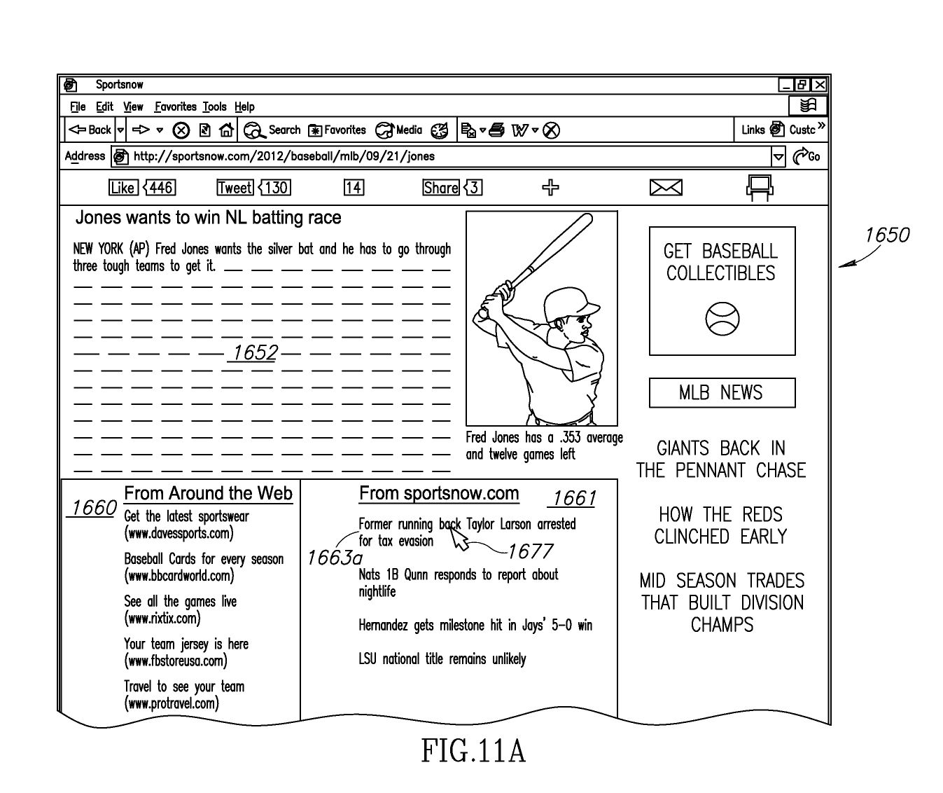

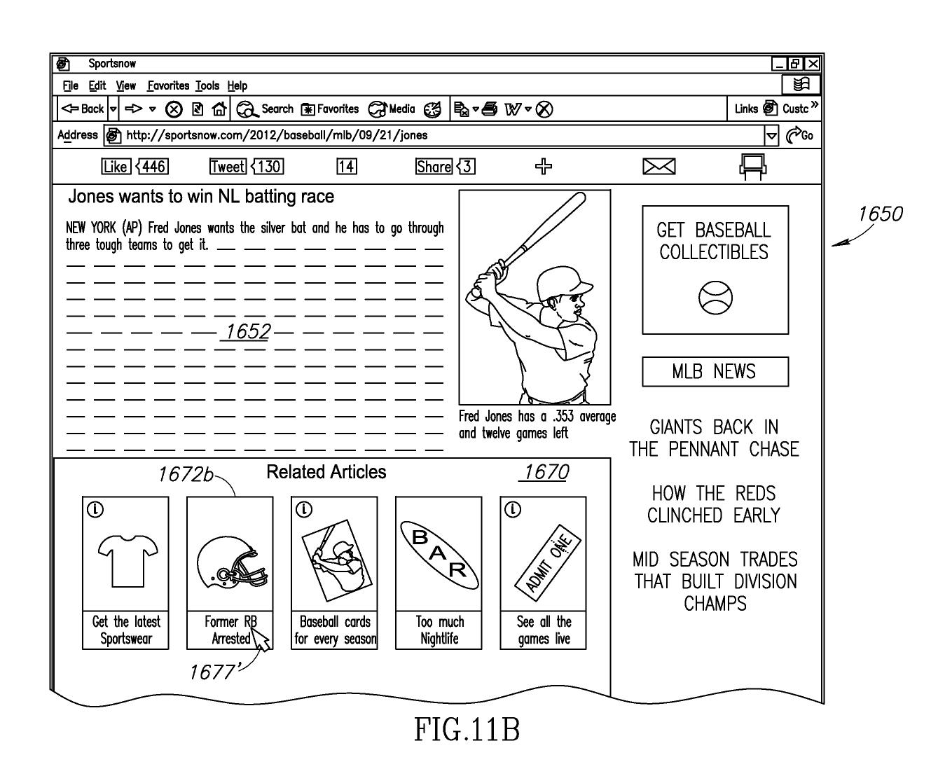

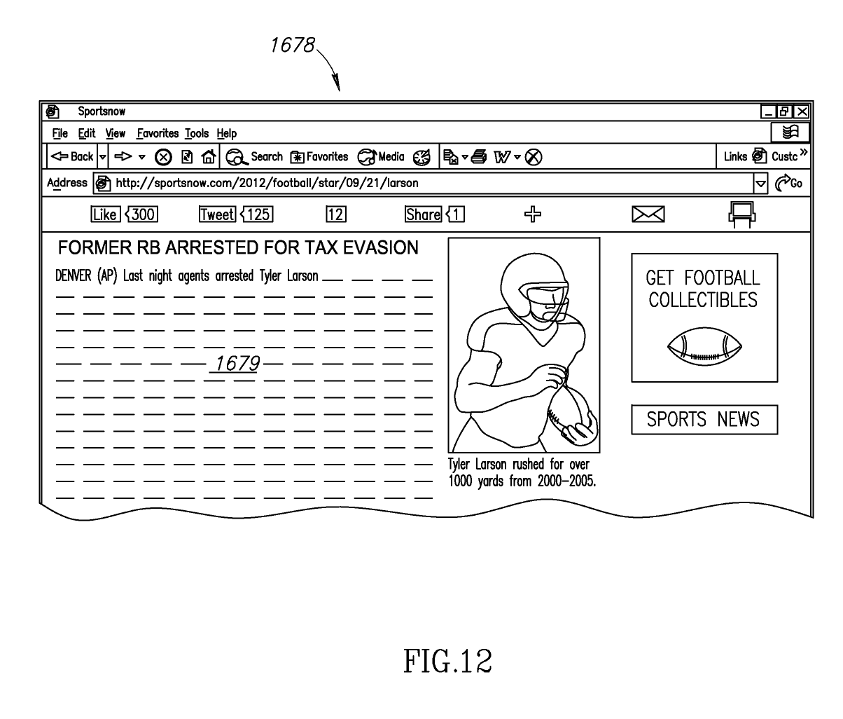

For example, turning to FIGS. 11A and 11B on web pages 1650 and 1650′ should the listing for “Former running back Taylor Larson arrested for tax evasion” 1663a (FIG. 11A), and image (with text “Former RB arrested” 1672b (FIG. 11B) be clicked on, as indicated by the arrows 1677 (FIG. 11A) 1677′ (FIG. 11B), the browser of the user 62a will be directed to the URL www.sportsnow.com/2012/football/star/09/21/larson, hosted by the third party server 1040a which hosts the web site for Sports Now Magazine, corresponding to the URL www.sportsnow.com. The user 62a will see the corresponding web page 1678, which includes the article 1679 entitled: “Former RB Arrested for Tax Evasion”, which is displayed on his monitor 62b, and shown in FIG. 12.

FIGS. 13A and 13B show another embodiment of the disclosed subject matter directed to publisher domains. For example, as shown in FIG. 13A, the domain of Publisher P1 Sports Now Magazine 1050a, includes publisher P1.1 Travel Now Magazine 1050x (www.travelnow.com-with content provided by corresponding third party server 1040x), Publisher P1.2 Bike Now Magazine 1050y (www.bikenow.com-with content provided by corresponding third party server 1040y), and Publisher P1.3 Boating Now Magazine 1050z (www.boatingnow.com-with content provided by corresponding third party server 1040z). This domain (the Publisher P1 domain) is also stored in the domains subdatabase 1034c (FIG. 4E). The system 1020 utilizes the processes described above, and shown in FIGS. 5A and 5B, except that the articles (including items of information and content) are selected (blocks 1560 and 1564 of FIG. 5B) from all members of the Publisher P1 domain. Accordingly, for example, the articles (including items of information and content) are selected, from publishers P1 (server 1040a), P1.1 (server 1040x), P1.2 (server 1040y) and P1.3 (server 1040z).

Turning to FIG. 13B, at area 1661 of web page 1650″, the articles provided from the domain, e.g., “From the sportsnow.com family” are: “Former running back Taylor Larson Arrested for tax evasion”-from Publisher P1, www.sportsnow.com 1040a, “10 Best Sports Vacations”-from Publisher P1.1, www.travelnow.com 1040x, “Should you take a loan for that boat?”-from Publisher P1.3, www.boatingnow.com 1040z, and “Great Bike trails this fall,”-from Publisher 1.2 www.bikenow.com 1040y.

FIGS. 14A and 14B show another embodiment of the disclosed subject matter directed to publisher networks. For example, as shown in FIG. 14A, the network of Publisher P1 Sports Now Magazine 1050a, includes publisher P2 Home Magazine 1050b (www.home.com-with content provided by corresponding third party server 1040b), and Publisher P3 80's Music 1050c (www.music80.com-with content provided by corresponding third party server 1040c). This network (the Publisher P1 network) is also stored in the networks subdatabase 1034d (FIG. 4F). The system 1020 utilizes the processes described above, and shown in FIGS. 5A and 5B, except that the articles (including items of information and content) are selected (blocks 1560 and 1564 of FIG. 5B) from all members of the Publisher P1 network. Accordingly, for example, the articles (including items of information and content) are selected, from publishers P1 (server 1040a), P2 (server 1040b), and P3 (server 1040c).

Turning to FIG. 14B, at area 1661 of web page 1650′″, the articles provided from the domain, e.g., “From the sportsnow.com Network” are: “Former running back Taylor Larson Arrested for tax evasion”-from Publisher P1, www.sportsnow.com 1040a, “The Best Home Repairs”-from Publisher P2, www.home.com 1040b, “Where are the 80′s Music Stars?”-from Publisher P3, www.music80.com 1040c, and “LSU national title remains unlikely”-from Publisher P1, www.sportsnow.com 1040a.

The above-described processes including portions thereof can be performed by software, hardware and combinations thereof. These processes and portions thereof can be performed by computers, computer-type devices, workstations, processors, micro-processors, other electronic searching tools and memory and other storage-type devices associated therewith. The processes and portions thereof can also be embodied in programmable storage devices and non-transitory computer readable media, for example, compact discs (CDs) or other discs including magnetic, optical, etc., readable by a machine or the like, or other computer usable storage media, including magnetic, optical, or semiconductor storage.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the disclosed subject matter disclosed subject matter have been described, so as to enable one of skill in the art to practice the present disclosed subject matter, the preceding description is intended to be exemplary only. It should not be used to limit the scope of the disclosed subject matter, which should be determined by reference to the following claims.

What is claimed is:

1. A method for providing content to electronic pages over a communications network, comprising:
a processor of a first computer system linked to the communications network, electronically crawling a first item of electronic content from a content source linked to the communications network for text;
a processor of the first computer system, electronically parsing the text;
obtaining, by a processor of the first computer system, at least one search term and at least one relevancy score for the at least one search term, based on at least a portion of the parsed text;
based on the at least one search term and the at least one relevancy score, and in response to the first item of electronic content being accessed on a first electronic page, a processor of the first computer system, searching the content source for at least one second item of electronic content to be accessible from a second electronic page for being viewed, the second electronic page including activatable data corresponding to the at least one second item of electronic content; and
providing, by the first computer system, the activatable data for accessing the at least one second item of electronic content over the communications network, to the second electronic page.

2. The method of claim 1, additionally comprising:
receiving, by the first computer system, over the communications network, the first item of electronic content from the content source.

3. The method of claim 2, wherein the content source includes at least one server associated with a content provider.

4. The method of claim 1, wherein the obtaining at least one search term and at least one relevancy score for the at least one search term, includes receiving, by the first computer system, the at least one search term and at least one relevancy score for the at least one search term from a second computer system linked to the communications network, over the communications network.

5. The method of claim 1, additionally comprising:
rendering, by the first computer system, the second electronic page to the browsing application of the computer of a user, the computer linked to the communications network, for display.

6. The method of claim 2, wherein the first item of electronic content includes articles.

7. The method of claim 1, wherein the second item of electronic content is selected from the group consisting of articles and advertisements.

8. The method of claim 7, wherein the articles and advertisement are presented in text.

9. The method of claim 7, wherein the articles and advertisement are presented in images.

10. The method of claim 1, wherein the first and second electronic pages include web pages.

11. The method of claim 1, wherein the first and second electronic pages are different.

12. The method of claim 1, wherein the at least one search term includes a keyword.

13. The method of claim 5, wherein the activatable data, includes a link, which when activated causes rendering of the at least one of the second items of electronic content to the browsing application of the computer of the user.

14. A computer system for providing content to electronic pages over a communications network, comprising:
at least one processor programmed to:
crawl a first item of electronic content from a content source linked to the communications network for text;
parse the text;
obtain at least one search term and at least one relevancy score for the at least one search term, based on at least a portion of the parsed text; and,
provide activatable data to access second items of electronic content, to a second electronic page; and;
a recommendation engine in electronic communication with the at least one processor, the recommendation engine configured for searching the content source for the second items of electronic content, to be provided as the activatable data for accessing each of the second items of electronic content, to the second electronic page for being viewed, the searching based on the at least one search term and the at least one relevancy score, and in response to the first item of electronic content being accessed on a first electronic page.

15. The system of claim 14, wherein the at least one processor is additionally programmed to:
render the second electronic page to the browsing application of the computer of a user for display.

16. A computerized system for providing content to electronic pages over a communications network, comprising:
a storage medium for storing computer components; and
a processor for executing the computer components comprising:
a first computer configured for crawling a first item of electronic content from a content source linked to the communications network for text;
a second computer component configured for parsing the text;
a third computer component configured for obtaining at least one search term and at least one relevancy score for the at least one search term, based on at least a portion of the parsed text;
a fourth computer component configured for searching the content source for second items of electronic content to be provided to a second electronic page as activatable data for being viewed on the second electronic page, the searching based on the at least one search term and the at least one relevancy score, and in response to the first item of electronic content being accessed on a first electronic page; and
a fifth computer component configured for providing the activatable data for accessing each of the second items of electronic content, to the second electronic page.

17. The system of claim 16, additionally comprising:
a sixth computer component configured for rendering the second electronic page to the browsing application of the computer of a user for display.

18. A computerized system for providing content to electronic pages over a communications network, comprising:
a storage medium having stored thereon data about a first item of electronic content from a content source linked to the communications network for text; and;
a computer, coupled to said storage medium, that is configured to: (a) crawl items of electronic content from a content source linked to the communications network for text; (b) parse the text; (c) obtain at least one search term and at least one relevancy score for the at least one search term, based on at least a portion of the parsed text; (d) search the content source for second items of electronic content to be provided as activatable data for accessing each of the second items of electronic content, to a second electronic page for being viewed, the searching based on the at least one search term and the at least one relevancy score, and in response to the first item of electronic content being accessed on a first electronic page; and (e) provide the activatable data for accessing each of the second items of electronic content, to the second electronic page.

19. The system of claim 18, wherein said computer is additionally configured to provide the activatable data in association with text or images.

20. The system of claim 18, wherein said computer is additionally configured to render the second electronic page to the browsing application of the computer of a user for display.
